(19) United States
(12) Patent Application Publication
(10) Pub. No.: US 2023/0295031 A1
(43) Pub. Date: Sep. 21, 2023

(54) METHODS OF MANUFACTURING A GLASS RIBBON

(71) Applicant: Corning Incorporated, Corning, NY (US)

(72) Inventors: Jeffrey Robert Amadon, Lexington, KY (US); Jean-Marc Martin Gerard Jouanno, Thomery (FR); Xinghua Li, Horseheads, NY (US); Bruce Warren Reding, Corning, NY (US); William Anthony Whedon, Corning, NY (US); Rui Zhang, Corning, NY (US); Peng Zhao, Corning, NY (US)

(21) Appl. No.: 18/007,951

(22) PCT Filed: Jun. 16, 2021
(86) PCT No.: PCT/US2021/037531

§ 371 Date: Dec. 2, 2022

Related U.S. Application Data
(60) Provisional application No. 63/041,339, filed on Jun. 19, 2020.

(51) Int. Cl. C03B 17/06

(52) U.S. Cl. CPC C03B 17/067

(57) ABSTRACT

A method of manufacturing a glass ribbon can comprise flowing a glass-forming ribbon along a travel path. The glass-forming ribbon can comprise a first major surface and a second major surface opposite the first major surface. A thickness can be defined between the first major surface and the second major surface. The method can comprise heating the first major surface of the glass-forming ribbon at a target location of the travel path while the glass-forming ribbon is travelling along the travel path. The heating can increase a temperature of the glass-forming ribbon at the target location to a heating depth of about 250 micrometers or less from the first major surface. The method can comprise cooling the glass-forming ribbon into the glass ribbon. Prior to the heating, the glass-forming ribbon at the target location can comprise an average viscosity in a range from about 1,000 Pascal-seconds to about 10¹¹ Pascal-seconds.

### CROSS-REFERENCE TO RELATED APPLICATIONS

This application claims the benefits of priority under 35 U.S.C. § 371 of International Application Serial No.: PCT/US2021/037531, filed on Jun. 16, 2021, which claims the benefit of priority under 35 U.S.C. § 119 of U.S. Provisional Application Serial No. 63/041,339 filed on Jun. 19, 2020, the contents of which are relied upon and incorporated herein by reference in their entirety.

### FIELD

The present disclosure relates generally to methods of manufacturing a glass ribbon and, more particularly, to methods of manufacturing a glass ribbon comprising heating a surface of the glass ribbon.

### BACKGROUND

Glass sheets can be used in photovoltaic applications or display applications, for example, liquid crystal displays (LCDs), electrophoretic displays (EPDs), organic light emitting diode displays (OLEDs), and plasma display panels (PDPs). Glass sheets are commonly fabricated by a flowing glass-forming material to a forming device whereby a glass web may be formed by a variety of web forming processes, for example, slot draw, float, down-draw, fusion down-draw, rolling, tube drawing, or up-draw. The glass web may be periodically separated into individual glass sheets. For a variety of applications, controlling a surface roughness of a glass sheet is desirable.

It is known to process glass sheets after forming the glass sheet. For example, chemical etching, mechanical grinding, and/or mechanical polishing can reduce surface roughness of a glass sheet. However, such post-forming processing can modify the surface properties of the glass ribbon. Consequently, there is a need for methods of manufacturing a glass ribbon that produces a glass ribbon comprising a low surface roughness without post-forming processing.

### SUMMARY

The following presents a simplified summary of the disclosure to provide a basic understanding of some embodiments described in the detailed description.

Embodiments of the disclosure can provide for high-quality glass ribbons and/or glass sheets. Heating a portion of a glass-forming ribbon to a small (e.g., 250 micrometers or less, 50 micrometers or less, 10 micrometers or less) depth from the first major surface can produce a glass ribbon and/or glass sheet with low surface roughness (e.g., about 5 nanometers or less). Further, the heating of the glass-forming ribbon can significantly reduce the surface roughness of the glass ribbon relative to forming a second glass ribbon without the heating (e.g., about 5% or less or in a range from about 0.01 to about 1% of the second glass ribbon’s surface roughness). The heating can provide the above-mentioned low surface roughness without subsequent processing (e.g., chemical etching, mechanical grinding, mechanical polishing) of the glass ribbon and/or glass sheet. Heating the glass-forming ribbon can reduce and/or eliminate surface roughness introduced, for example, by rollers and/or a forming device. Reducing the surface roughness can enable the resulting glass ribbons and/or glass sheets to meet more stringent design specifications on surface roughness while reducing waste from non-conforming glass ribbons and/or glass sheets.

Embodiments of the disclosure can increase processing efficiency in manufacturing glass ribbons. Heating the glass-forming ribbon when the glass-forming ribbon is in a viscous state (e.g., from about 1,000 Pascal-seconds to about 10¹¹ Pascal-seconds) can be performed inline with other aspects of manufacturing the glass ribbon from glass-forming material, for example, between the forming device and dividing the glass ribbon into a plurality of glass sheets. Providing the heating inline can reduce the time and/or space requirements for manufacturing the glass ribbon since demand for subsequent processing of the glass ribbon and/or glass sheet can be reduced and/or eliminated. Additionally, the labor and/or equipment costs associated with subsequent processing of the glass ribbon and/or glass sheet can be reduced and/or eliminated.

Embodiments of the disclosure can comprise heating the glass-forming ribbon when the glass-forming ribbon at an elevated temperature (e.g., from about 500° C. to about 1300° C.). Heating the glass-forming ribbon when the glass-forming ribbon is at an elevated temperature can produce a glass ribbon and/or glass sheet with low or no residual stress from the heating, for example, because the glass-forming ribbon is in the viscous regime during the heating. Additionally, heating the glass-forming ribbon when the glass-forming ribbon is at an elevated temperature can reduce energy required to heat a portion of the glass-forming ribbon within a small (e.g., 250 micrometers or less, 50 micrometers or less, 10 micrometers or less) depth from the first major surface to obtain a sufficient temperature and/or viscosity to reduce the surface roughness.

Embodiments of the disclosure can localize the heating of the glass-forming ribbon to a small (e.g., 250 micrometers or less, 50 micrometers or less, 10 micrometers or less) depth from the first major surface. Localizing the heating can decrease a viscosity of the portion (e.g., from about 100 Pascal-seconds to about 1,000 Pascal-seconds), which can, for example, facilitate smoothing of the first major surface via surface tension of the glass-forming material comprising the glass-forming ribbon. Additionally, localizing the heating can decrease the surface roughness of the first major surface without significantly heating the rest of the thickness of the glass-forming ribbon at that location, which can prevent changes in thickness or deformation of the shape of the glass-forming ribbon. Also, localizing the heating can reduce the energy required to reduce the surface roughness of the first major surface. Further reduction in the energy required and/or preventing deformation of the ribbon can be enabled by selecting heating comprising a small absorption depth (e.g., about 10 micrometers or less) and/or selecting a residence time of the heating to heat the glass-forming ribbon to a small heating depth (e.g., 250 micrometers or less, about 50 micrometers or less).

In some embodiments, a method of manufacturing a glass ribbon can comprise flowing a glass-forming ribbon along a travel path. The glass-forming ribbon can comprise a first major surface and a second major surface opposite the first major surface. A thickness of the glass-forming ribbon can be defined between the first major surface and the second major surface. A width can extend across the travel path. The method can comprise heating the first major surface of the glass-forming ribbon at a target location of the travel path while the glass-forming ribbon is travelling along the travel path. The heating can increase a temperature of the glass-forming ribbon at the target location to a heating depth of about 250 micrometers or less from the first major surface. The method can comprise cooling the glass-forming ribbon into the glass ribbon. Prior to the heating, the glass-forming ribbon at the target location can comprise an average viscosity in a range from about 1,000 Pascal-seconds to about 10¹¹ Pascal-seconds.

In further embodiments, the method can further comprise contacting the first major surface of the glass-forming ribbon across substantially the entire width of the glass-forming ribbon with a roller at a location on the travel path upstream of the target location.

In further embodiments, the method can further comprise forming the glass-forming ribbon by flowing glass-forming material through an orifice of a forming device.

In further embodiments, the average viscosity at the target location can be in a range from about 1,000 Pascal-seconds to about 10^{6.6} Pascal-seconds.

In even further embodiments, the average viscosity at the target location can be in a range from about 10,000 Pascal-seconds to about 20,000 Pascal-seconds.

In further embodiments, the average viscosity at the target location can be in a range from about 10^{6.6} Pascal-seconds to about 10¹¹ Pascal-seconds.

In further embodiments, prior to the heating, an average temperature of the glass-forming ribbon at the target location can be in a range from about 500° C. to about 1300° C.

In even further embodiments, the average temperature of the glass-forming ribbon at the target location can be in a range from about 750° C. to about 1250° C.

In still further embodiments, the average temperature of the glass-forming ribbon at the target location can be in a range from about 900° C. to about 1100° C.

In even further embodiments, the average temperature of the glass-forming ribbon at the target location can be in a range from about 500° C. to about 750° C.

In further embodiments, a surface roughness of the first major surface of the glass ribbon before subsequent processing of the glass ribbon can be about 5 nanometers (nm) or less.

In even further embodiments, the surface roughness Ra of the first major surface of the glass ribbon can be in a range from about 0.1 nanometers to about 2 nanometers.

In even further embodiments, the surface roughness Ra of the first major surface of the glass ribbon before subsequent processing of the glass ribbon can be about 5% or less than a surface roughness surface roughness Ra of a second glass ribbon before subsequent processing of the second glass ribbon. The second glass ribbon can be manufactured identically to the glass ribbon except for the heating.

In still further embodiments, the surface roughness Ra of the first major surface of the glass ribbon can be in a range from about 0.01% to about 1% of the surface roughness Ra of the second glass ribbon.

In further embodiments, the heating the first major surface at the target location can transfer energy to the glass-forming ribbon at a rate in a range from about 0.1 kilowatt per square centimeter to about 100 kilowatts per square centimeter.

In even further embodiments, the heating the first maj or surface at the target location can transfer energy to the glass-forming ribbon at a rate in a range from about 1 kilowatt per square centimeter to about 20 kilowatt per square centimeter.

In even further embodiments, substantially all of the energy transferred to the glass-forming ribbon at the target location can be absorbed within about 10 micrometers or less from the first major surface at the target location.

In further embodiments, the heating depth can be about 10 micrometers or less.

In further embodiments, wherein an absorption depth of a glass-forming material of the glass-forming ribbon at the target location can be of about 50 micrometers or less.

In even further embodiments, the absorption depth can be about 10 micrometers or less.

In further embodiments, the method can further comprise heating the second major surface of the glass-forming ribbon at a second target location of the travel path while the glass-forming ribbon is travelling along the travel path. The heating can increase a temperature of the glass-forming ribbon at the second target location to a heating depth of about 250 micrometers or less from the second major surface.

In even further embodiments, the heating the second major surface can increase the temperature of the glass-forming ribbon at the second target location to a heating depth of about 10 micrometers or less from the second major surface.

In even further embodiments, a surface roughness Ra of the second major surface of the glass ribbon before subsequent processing of the glass ribbon can be about 5 nanometers or less.

In still further embodiments, the surface roughness Ra of the second major surface of the glass ribbon can be in a range from about 0.1 nanometers to about 2 nanometers.

In still further embodiments, the surface roughness Ra of the second major surface of the glass ribbon before subsequent processing of the glass ribbon can be about 5% or less than a surface roughness Ra of a second glass ribbon before subsequent processing of the second glass ribbon. The second glass ribbon can be manufactured identically to the glass ribbon except for the heating.

In still further embodiments, the surface roughness Ra of the second major surface of the glass ribbon can be in a range from about 0.01% to about 1% of the surface roughness Ra of the second glass ribbon.

In even further embodiments, the heating the second major surface of the glass-forming ribbon at the second target location can transfer energy to the second major surface at a rate in a range from about 0.1 kilowatts per square centimeter to about 100 kilowatts per square centimeter.

In still further embodiments, the heating the second major surface at the second target location transfers energy to the second major surface at a rate in a range from about 1 kilowatt square centimeter to about 20 kilowatts per square centimeter.

In further embodiments, the heating can comprise impinging the first major surface of the glass-forming ribbon at the target location with a laser beam.

In even further embodiments, the laser beam can comprise a wavelength in a range from about 1.5 micrometers to about 20 micrometers.

In still further embodiments, the wavelength of the laser beam can be in a range from about 5 micrometers to about 15 micrometers.

In even further embodiments, the wavelength of the laser beam can be in a range from about 9 micrometers to about 12 micrometers.

In even further embodiments, a width of the laser beam in a direction transverse to the travel path can be about 50% or more of the width of the glass-forming ribbon at the target location.

In still further embodiments, the width of the laser beam can be in a range from about 80% to about 100% of the width of the glass-forming ribbon at the target location.

In even further embodiments, the method can further comprise scanning the laser beam across a portion of the width of the glass-forming ribbon at the target location.

In even further embodiments, the method can further comprise scanning the laser beam across a portion of the width of the glass-forming ribbon at the target location.

In still further embodiments, the portion can be in a range from about 80% to 100% of the width of the glass-forming ribbon at the target location.

In even further embodiments, the impinging can comprise impinging the first major surface at the target location with a plurality of laser beams.

In still further embodiments, the plurality of laser beams impinging the glass-forming ribbon at the target location can be arranged in a row along a direction of the width of the glass-forming ribbon.

In even further embodiments, the laser beam can be a substantially continuous laser beam comprising a substantially constant fluence.

In further embodiments, the heating can comprise emitting a flame with a burner and heating the glass-forming ribbon at the target location with the flame.

In even further embodiments, the burner can comprise a plurality of burners emitting a plurality of flames. The plurality of flames can heat the glass-forming ribbon at the target location.

In still further embodiments, the plurality of flames can be arranged in a row along a direction of the width of the glass-forming ribbon.

In even further embodiments, the burner can emit a flame of substantially constant power.

In further embodiments, the method can further comprise dividing the glass ribbon into a plurality of glass sheets.

In some embodiments, methods of making an electronic product can comprise placing electrical components at least partially within a housing, the housing comprising a front surface, a back surface, and side surfaces, and the electrical components comprising a controller, a memory, and a display, wherein the display is placed at or adjacent the front surface of the housing. The methods can further comprise disposing a cover substrate over the display. At least one of a portion of the housing or the cover substrate comprises a portion of the glass ribbon manufactured by the method of any one of the above embodiments.

In some embodiments, an electronic product can comprise a housing comprising a front surface, a back surface, and side surfaces. The electronic product can comprise electrical components at least partially within the housing. The electrical components can comprise a controller, a memory, and a display. The display can be at or adjacent to the front surface of the housing. The electronic product can comprise a cover substrate disposed over the display. At least one of a portion of the housing or the cover substrate can comprise a portion of the glass ribbon of any of the above embodiments.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings. It is to be understood that both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

These and other features, aspects, and advantages are better understood when the following detailed description is read with reference to the accompanying drawings, in which:

FIG. 1 schematically illustrates an exemplary embodiment of a glass manufacturing apparatus in accordance with some embodiments of the disclosure;

FIG. 2 shows a view of a glass manufacturing in accordance with some embodiments of the disclosure;

FIG. 3 illustrates a cross-sectional view of a glass manufacturing apparatus taken along line 3-3 of FIG. 2 in accordance with some embodiments of the disclosure;

FIG. 4 illustrates a cross-sectional view of a glass manufacturing apparatus taken along line 4-4 of FIG. 2 in accordance with some embodiments of the disclosure;

FIG. 5 illustrates a cross-sectional view of a glass manufacturing apparatus taken along line 5-5 of FIGS. 2-3 in accordance with some embodiments of the disclosure;

FIG. 6 illustrates another cross-sectional view of a glass manufacturing apparatus taken along line 5-5 of FIGS. 2-3 in accordance with some embodiments of the disclosure;

FIG. 7 is an enlarged view 7 of FIG. 5;

FIG. 8 is another enlarged view 7 of FIG. 5;

FIG. 9 is a schematic plan view of an example electronic device according to some embodiments; and

FIG. 10 is a schematic perspective view of the example electronic device of FIG. 9.

### DETAILED DESCRIPTION

Embodiments will now be described more fully hereinafter with reference to the accompanying drawings in which exemplary embodiments are shown. Whenever possible, the same reference numerals are used throughout the drawings to refer to the same or like parts. However, this disclosure may be embodied in many different forms and should not be construed as limited to the embodiments set forth herein.

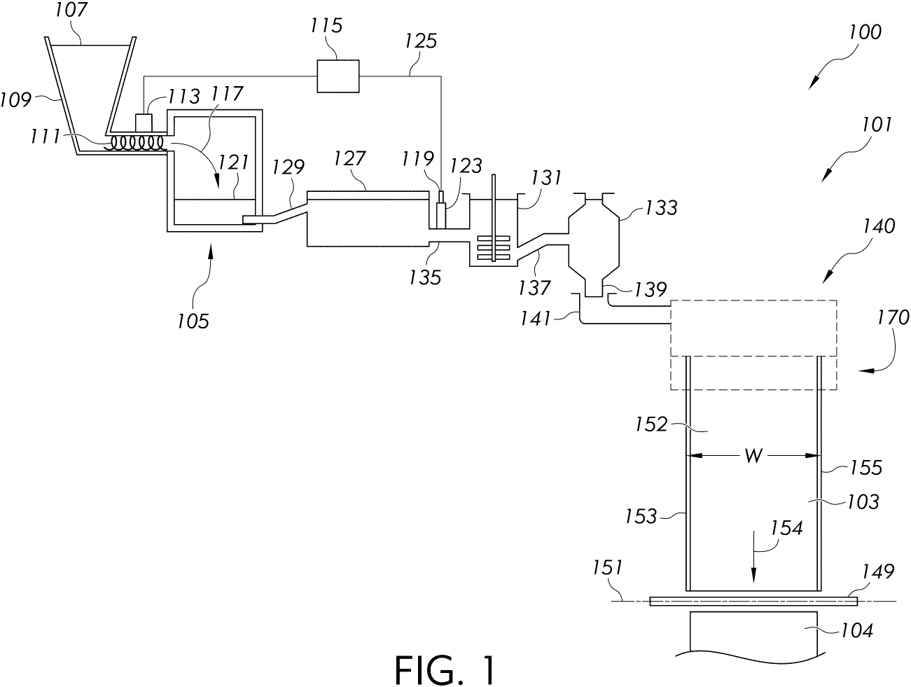

The present disclosure relates to methods for manufacturing a glass ribbon that may use manufacturing apparatuses and may be employed in methods for manufacturing a glass or glass-ceramic article (e.g., a glass ribbon, ribbon of glass-forming material) from a quantity of glass-forming material. For example, FIGS. 1-4 illustrate a glass manufacturing apparatus comprising a down-draw apparatus (e.g., press rolling, slot draw) in the context of manufacturing a ribbon of glass-forming material that can be cooled into a glass ribbon. Unless otherwise noted, a discussion of features of embodiments of the glass manufacturing apparatus can apply equally to corresponding features of other forming apparatuses used in the production of glass or glass-ceramic articles. Examples of glass forming apparatuses include a slot draw apparatus, float bath apparatus, down-draw apparatus, up-draw apparatus, press-rolling apparatus or other glass article manufacturing apparatus that can be used to form a glass article (e.g., glass ribbon, ribbon of glass-forming material) from a quantity of glass-forming material. In some embodiments, a glass article from any of these processes may then be divided to provide a plurality of glass articles (e.g., separated glass ribbons, separated glass sheets) suitable for further processing into an application (e.g., a display application, a electronic device). For example, separated glass ribbons can be used in a wide range of applications comprising liquid crystal displays (LCDs), electrophoretic displays (EPDs), organic light emitting diode displays (OLEDs), plasma display panels (PDPs), touch sensors, photovoltaics, appliances (e.g., stovetops), or the like. Such displays can be incorporated, for example, into mobile phones, tablets, laptops, watches, wearables and/or touch capable monitors or displays.

As schematically illustrated in FIG. 1, in some embodiments, a glass manufacturing apparatus 100 can comprise a glass forming apparatus 101 including a forming device 140 designed to produce a glass ribbon 103 from a quantity of glass-forming material 121. As used herein, the term “glass ribbon” refers to material after it is drawn from the forming device 140 even when the material is not in a glassy state (i.e., above its glass transition temperature). In some embodiments, the glass ribbon 103 can comprise a central portion 152 disposed between opposite, edge beads formed along a first outer edge 153 and a second outer edge 155 of the glass ribbon 103. Additionally, in some embodiments, a glass sheet 104 can be separated from the glass ribbon 103 along a separation path 151 by a glass separator 149 (e.g., scribe, score wheel, diamond tip, laser). In some embodiments, before or after separation of the glass sheet 104 from the glass ribbon 103, the edge beads formed along the first outer edge 153 and the second outer edge 155 can be removed to provide the central portion 152 as a glass sheet 104 having a more uniform thickness.

In some embodiments, the glass manufacturing apparatus 100 can comprise a melting vessel 105 oriented to receive batch material 107 from a storage bin 109. The batch material 107 can be introduced by a batch delivery device 111 powered by a motor 113. In some embodiments, a controller 115 can optionally be operated to activate the motor 113 to introduce an amount of batch material 107 into the melting vessel 105, as indicated by arrow 117. The melting vessel 105 can heat the batch material 107 to provide glass-forming material 121. In some embodiments, a glass melt probe 119 can be employed to measure a level of glass-forming material 121 within a standpipe 123 and communicate the measured information to the controller 115 by way of a communication line 125.

Additionally, in some embodiments, the glass manufacturing apparatus 100 can comprise a first conditioning station including a fining vessel 127 located downstream from the melting vessel 105 and coupled to the melting vessel 105 by way of a first connecting conduit 129. In some embodiments, glass-forming material 121 can be gravity fed from the melting vessel 105 to the fining vessel 127 by way of the first connecting conduit 129. For example, in some embodiments, gravity can drive the glass-forming material 121 through an interior pathway of the first connecting conduit 129 from the melting vessel 105 to the fining vessel 127. Additionally, in some embodiments, bubbles can be removed from the glass-forming material 121 within the fining vessel 127 by various techniques.

In some embodiments, the glass manufacturing apparatus 100 can further comprise a second conditioning station including a mixing chamber 131 that can be located downstream from the fining vessel 127. The mixing chamber 131 can be employed to provide a homogenous composition of glass-forming material 121, thereby reducing or eliminating inhomogeneity that may otherwise exist within the glass-forming material 121 exiting the fining vessel 127. As shown, the fining vessel 127 can be coupled to the mixing chamber 131 by way of a second connecting conduit 135. In some embodiments, glass-forming material 121 can be gravity fed from the fining vessel 127 to the mixing chamber 131 by way of the second connecting conduit 135. For example, in some embodiments, gravity can drive the glass-forming material 121 through an interior pathway of the second connecting conduit 135 from the fining vessel 127 to the mixing chamber 131.

Additionally, in some embodiments, the glass manufacturing apparatus 100 can comprise a third conditioning station including a delivery vessel 133 that can be located downstream from the mixing chamber 131. In some embodiments, the delivery vessel 133 can condition the glass-forming material 121 to be fed into an inlet conduit 141. For example, the delivery vessel 133 can function as an accumulator and/or flow controller to adjust and provide a consistent flow of glass-forming material 121 to the inlet conduit 141. As shown, the mixing chamber 131 can be coupled to the delivery vessel 133 by way of a third connecting conduit 137. In some embodiments, glass-forming material 121 can be gravity fed from the mixing chamber 131 to the delivery vessel 133 by way of the third connecting conduit 137. For example, in some embodiments, gravity can drive the glass-forming material 121 through an interior pathway of the third connecting conduit 137 from the mixing chamber 131 to the delivery vessel 133. As further illustrated, in some embodiments, a delivery pipe 139 can be positioned to deliver glass-forming material 121 to the inlet conduit 141 of the forming device 140.

Various embodiments of forming devices can be provided in accordance with features of the disclosure including a forming device with a wedge for fusion drawing the glass ribbon, a forming device with a slot to slot draw the glass ribbon, or a forming device provided with press rollers to press roll the glass ribbon from the forming device. For example, in some embodiments, the glass-forming material 121 can be delivered from the inlet conduit 141 to the forming device 140. The glass-forming material 121 can then be formed into the glass ribbon 103 based at least in part on the structure of the forming device 140. In some embodiments, the width “W” of the glass ribbon 103 can extend between the first outer edge 153 of the glass ribbon 103 and the second outer edge 155 of the glass ribbon 103. In some embodiments, the forming device 140 can comprise a ceramic refractory material, for example, zircon, zirconia, mullite, alumina, or combinations thereof. In some embodiments, the forming device 140 can comprise a metal, for example, platinum, rhodium, iridium, osmium, palladium, ruthenium, or combinations thereof. In further embodiments, one or more surfaces of the forming device 140 can comprise a metal to provide a non-reactive surface that can contact the glass-forming material 121.

In some embodiments, the width “W” of the glass ribbon 103 can be about 20 millimeters (mm) or more, about 50 mm or more, about 100 mm or more, about 500 mm or more, about 1,000 mm or more, about 2,000 mm or more, about 3,000 mm or more, about 4000 mm or more, although other widths can be provided in further embodiments. In some embodiments, the width “W” of the glass ribbon 103 can be in a range from about 20 mm to about 4,000 mm, from about 50 mm to about 4,000 mm, from about 100 mm to about 4,000 mm, from about 500 mm to about 4,000 mm, from about 1,000 mm to about 4,000 mm, from about 2,000 mm to about 4,000 mm, from about 3,000 mm to about 4,000 mm, from about 20 mm to about 3,000 mm, from about 50 mm to about 3,000 mm, from about 100 mm to about 3,000 mm, from about 500 mm to about 3,000 mm, from about 1,000 mm to about 3,000 mm, from about 2,000 mm to about 3,000 mm, from about 2,000 mm to about 2,500 mm, or any ranges or subranges therebetween.

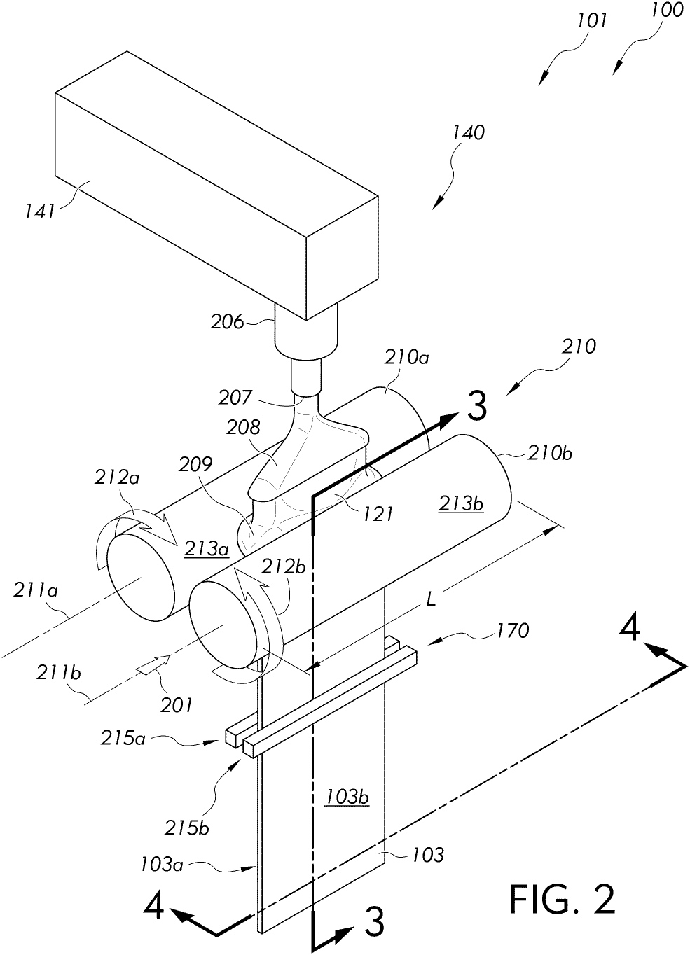

FIG. 2 schematically illustrates a perspective view of exemplary embodiments of the glass manufacturing apparatus 100 including the glass forming apparatus 101 comprising the forming device 140. In some embodiments, as shown, the inlet conduit 141 can provide (e.g., supply) a quantity of glass-forming material 121 to the forming device 140. For example, in some embodiments, the forming device 140 can include a delivery conduit 206 connect to the inlet conduit 141 and an outlet port 207 connected to the delivery conduit 206.

The outlet port can deliver the glass-forming material 121 to a pair of forming rollers 210 in a variety of ways. For example, as shown in FIG. 2, in some embodiments, the outlet port 207 can include an optional orifice 208 (e.g., flared orifice) to cause the quantity of glass-forming material 121 to flow downwardly from the outlet port 207 and spread into an elongated stream of glass-forming material 121 extending along a length “L” of the pair of forming rollers 210. Alternatively, although not shown, in some embodiments, the orifice can deliver a stream (e.g., circular stream, elliptical stream, rectangular stream, etc.) of glass-forming material to the pair of forming rollers. In some embodiments, the glass-forming material can be configured to flow through the orifice 208. In further embodiments, although not shown, the orifice can form a ribbon from the glass-forming material (e.g., in a slot draw process), which can omit the pair of forming rollers. In further embodiments, the orifice can introduce a roughness to a surface of the ribbon formed by the orifice. For example, the orifice can provide a ribbon with a substantially uniform thickness while still introducing roughness to the surface of the ribbon as a result of wear of the orifice.

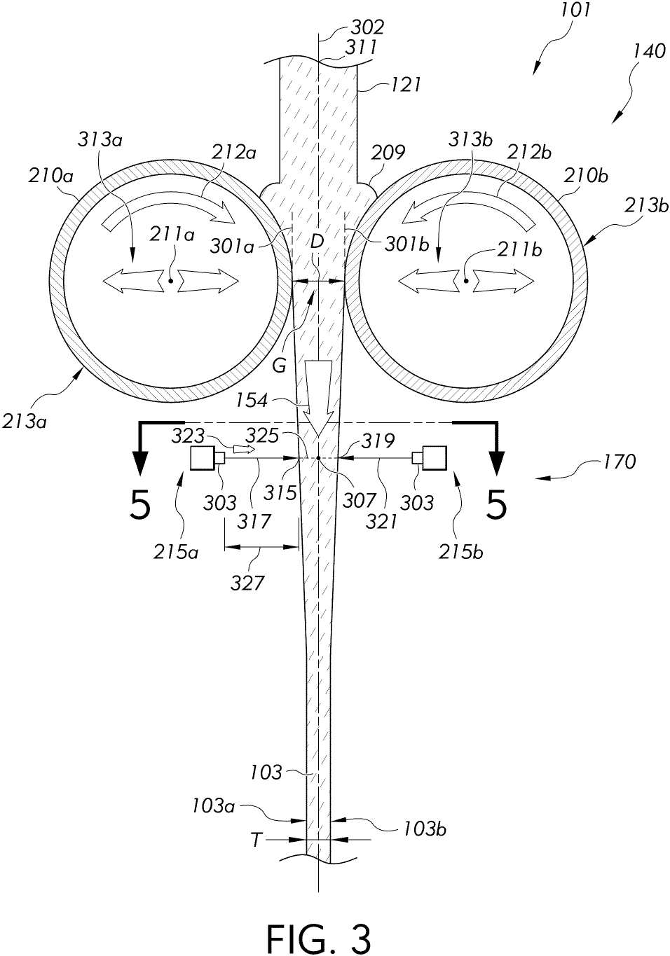

As shown in FIGS. 2-3, the pair of forming rollers 210 can comprise a first forming roller 210a rotatable about a first axis 211a as indicated by rotation direction 212a and a second forming roller 210b rotatable about a second axis 211b as indicated by rotation direction 212b. In some embodiments, as shown in FIG. 3, the first axis 211a can be parallel with respect to the second axis 211b and the first forming roller 210a can be spaced from the second forming roller 210b such that a minimum distance “D” between the first forming roller 210a and the second forming roller 210b defines a gap “G”. As used herein, the minimum distance “D” is defined as the minimum distance at a point along the length “L” of the forming rollers 210. As shown in FIG. 3, an outer peripheral surface 213a of the first forming roller 210a can be spaced from the outer peripheral surface 213b of the second forming roller 210b wherein the minimum distance “D” is defined between the outer peripheral surfaces, for example, by points of tangency along parallel tangent lines 301a, 301b.

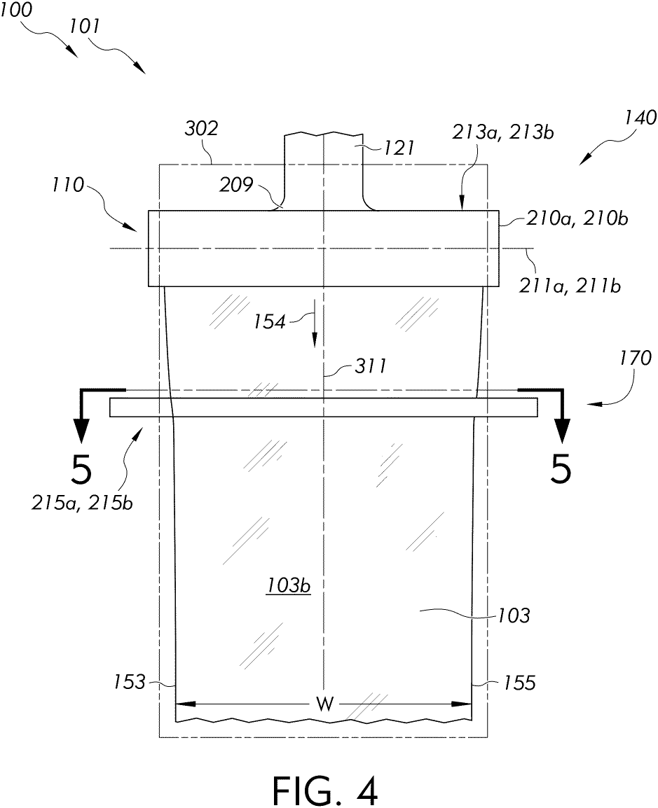

In some embodiments, the minimum distance may be uniform along the length “L” of the pair of forming rollers 210. For example, the outer peripheral surface 213a, 213b of each forming roller 210a, 210b can comprise a uniform outer diameter along the length “L” such that the gap “G” includes the same minimum distance “D” at each point along the length “L” of the pair of forming rollers 210. Such a configuration can provide a ribbon of glass-forming material exiting the gap “G” that has an initial substantially uniform thickness along the length “L” of the pair of forming rollers 210. In some embodiments, as shown in FIGS. 2 and 4, the pair of forming rollers 210 can extend for the length “L” that can be extend for the entire width “W” or more of the glass-forming ribbon that can be subsequently cooled to form the glass ribbon 103. While not shown, in some embodiments, only one roller can be provided, and the roller can extend for the entire width or more of the glass-forming ribbon. However, the pair of forming rollers can introduce a roughness to a surface of the ribbon formed by the pair of forming rollers. For example, the pair of forming rollers can provide a ribbon with a substantially uniform thickness while still introducing roughness to the surface of the ribbon as a result of wear of the rollers.

In further embodiments, the minimum distance may vary along the length “L” of the pair of forming rollers 210. For example, the outer peripheral surface 213a, 213b of each forming roller 210a, 210b can comprise a varying outer diameter along the length “L” such that the gap includes the varying minimum distances “D” at points along the length “L” of the pair of forming rollers 210. In some embodiments, the outer peripheral surface of each forming roller can include a reduced diameter at a central portion of each forming roller that increases towards the opposite ends of each forming roll. In such embodiments, a diameter of a central portion of each forming roller can be less than a diameter of end portions of each forming roller such that the minimum distance at a central point along the length “L” of the pair of forming rollers 210 is greater than the minimum distance at end points along the length “L” of the pair of forming rollers 210. Such a configuration can provide a ribbon of glass-forming material exiting the gap that has an initial thickness along the length “L” of the pair of forming rollers 210 with an increased thickness at a central portion of the ribbon of glass-forming material that tapers towards reduced thicknesses at outer edge portions of the ribbon of glass-forming material.

In the illustrated embodiment, the glass forming apparatus 101 includes a draw plane 302. As shown in FIG. 3, the ribbon of glass-forming material can be drawn from the pair of forming rollers 210 along the draw plane 302 in a draw direction 154. The draw plane 302 can be parallel with respect to the first axis 211a and the second axis 211b. In some embodiments, the draw plane can bisect the minimum distance “D” between the pair of forming rollers 210. As such, the ribbon of glass-forming material may be drawn along the draw plane 302 from the pair of forming rollers 210 without substantial twisting of the ribbon of glass-forming material about a central elongated axis of the ribbon of glass-forming material. As shown, in some embodiments, the draw plane 302 may extend along (e.g., comprise, be parallel with) the draw direction 154. As such, as shown in the exemplary embodiment, the draw plane 302 can be substantially flat while being parallel with respect to the first axis 211a and the second axis 211b. Although not shown, the draw plane may alternatively comprise a curved draw plane that is still parallel with respect to the first axis 211a and the second axis 211b. For instance, in some embodiments, the draw plane 302 may begin as a vertical draw plane as it exits the gap “G” of the pair of forming rollers 210 and then curve into a horizontal draw plane as the glass ribbon is drawn along a horizontal direction. In some embodiments, as shown in FIGS. 1 and 4, a direction of the average width “W” of the glass ribbon 103 can be substantially perpendicular to the draw direction 154 while being parallel to the draw plane 302. In further embodiments, the direction of the average width “W” of the glass ribbon 103 and the draw direction 154 can define the draw plane 302.

Throughout the disclosure, the travel path 311 is defined as the path that the glass-forming material 121 follows from when it enters the forming device 140 until it has cooled to its strain point (i.e., the temperature at which the viscosity of the glass-forming material 121 comprising the glass ribbon 103 exceeds 10^{13.5} Pascal-seconds). The glass-forming material 121 may cool to its strain point as a glass ribbon 103 before it reaches the separation path 151, although the glass-forming material 121 may cool to its strain point after it crosses the separation path 151 as a glass sheet 104 in further embodiments. For instance, as shown in FIGS. 2-5, the travel path 311 can be defined as the path the glass-forming material 121 travels as it flows from the forming device 140 comprising the orifice 208 and/or the pair of forming rollers 210. As shown in FIG. 3, the glass-forming material 121 can be drawn in the draw direction 154 along the travel path 311. As shown in FIG. 3, the travel path 311 can extend in the draw direction 154. In some embodiments, as shown in FIGS. 3-4, the draw plane 302 can comprise the travel path 311.

In some embodiments, the glass separator 149 (see FIG. 1) can then separate the glass sheet 104 from the glass ribbon 103 along the separation path 151. As illustrated, in some embodiments, the separation path 151 can extend along the width “W” of the glass ribbon 103 between the first outer edge 153 and the second outer edge 155. In some embodiments, as shown in FIG. 4, the width “W” of the glass ribbon 103 can extend across the travel path 311. Additionally, in some embodiments, the separation path 151 can extend perpendicular to the draw direction 154 of the glass ribbon 103. Moreover, in some embodiments, the draw direction 154 can define a direction along which the glass ribbon 103 can be drawn from the forming device 140. In some embodiments, the glass ribbon 103 can comprise a speed as it traverses along draw direction 154 of about 1 millimeters per second (mm/s) or more, about 10 mm/s or more, about 50 mm/s or more, about 100 mm/s or more, or about 500 mm/s or more, for example, in a range from about 1 mm/s to about 500 mm/s, from about 10 mm/s to about 500 mm/s, from about 50 mm/s to about 500 mm/s, from about 100 mm/s to about 500 mm/s, and all ranges and subranges therebetween.

As shown in FIGS. 2 and 4, in some embodiments, the glass ribbon 103 is drawn from forming device 140 with a first major surface 103a of the glass ribbon 103 and a second major surface 103b of a glass-forming ribbon facing opposite directions. Once the glass-forming ribbon is cooled to form a glass ribbon 103, the first major surface 103a and the second major surface 103b can define an average thickness “T” of the glass ribbon 103. In some embodiments, a direction of the average thickness “T” of the glass ribbon 103 can be substantially perpendicular to both the draw direction 154 and the average width “W”. In some embodiments, a direction of the average thickness “T” of the glass ribbon 103 can be substantially perpendicular to the draw plane 302. In some embodiments, the average thickness “T” of the central portion 152 of the glass ribbon 103 can be about 5 mm or less, about 2 mm or less, about 1 mm or less, about 500 micrometers (µm), about 300 µm or less, about 200 µm or less, about 100 µm or less, although other thicknesses may be provided in further embodiments. For example, in some embodiments, the average thickness “T” of the glass ribbon 103 can be in a range from about 25 µm to about 5 mm, from about 25 µm to about 1 µm, from about 50 µm to about 750 µm, from about 100 µm to about 700 µm, from about 200 µm to about 600 µm, from about 300 µm to about 500 µm, from about 50 µm to about 500 µm, from about 50 µm to about 700 µm, from about 50 µm to about 600 µm, from about 50 µm to about 500 µm, from about 50 µm to about 400 µm, from about 50 µm to about 300 µm, from about 50 µm to about 200 µm, or from about 50 µm to about 100 µm, including all ranges and subranges of thicknesses therebetween. In addition, the glass ribbon 103 can comprise a variety of compositions including, but not limited to, soda-lime glass, aluminosilicate glass, borosilicate glass, aluminoborosilicate glass, alkali-containing glass, or alkali-free glass, any of which may be free of lithia or not.

As used herein, “glass-forming” material refers to material that can be cooled into a ribbon of glass (i.e., a glass ribbon) in an elastic state. In some embodiments, the glass-forming material can be in a viscous state. In some embodiments, the glass-forming material can be in a viscoelastic state. Without wishing to be bound by theory, in the viscous state, deformation of the material can result in plastic deformation, and the material may comprise little or no residual stress from the deformation. Without wishing to be bound by theory, in the viscoelastic state, deformation of the material can result in plastic deformation of the material, but the material may comprise residual stress from the deformation. Without wishing to be bound by theory, in the elastic state, deformation of the material can result in elastic deformation of the material. In some embodiments, the glass-forming material can be free of lithia or not and can comprise a silicate, a borosilicate, an aluminosilicate, an aluminoborosilicate, or a soda lime based-composition.

The glass-forming material can be cooled to form a glass ribbon. In some embodiments, the glass ribbon can be strengthened or non-strengthened and, free of lithia or not, and may include soda lime glass, alkali aluminosilicate glass, alkali containing borosilicate glass and alkali aluminoborosilicate glass. As used herein, the term “strengthened” can refer to a glass ribbon or glass sheet that has been chemically strengthened, for example through ion-exchange of larger ions for smaller ions in the surface of the glass ribbon or glass sheet. However, in further embodiments, a glass ribbon or glass sheet can be “strengthened” by other techniques such as thermal tempering, or utilizing a mismatch of the coefficient of thermal expansion between portions of the glass ribbon or glass sheet to create surface compressive stress and central tension regions. As discussed above, the glass ribbon can be divided into a plurality of glass sheets.

In some embodiments, the glass ribbon and/or the plurality of glass sheets can be glass-based. As used herein, “glass-based” includes both glasses and glass-ceramics, wherein glass-ceramics have one or more crystalline phases and an amorphous, residual glass phase. A glass-based material (e.g., glass-based ribbon, glass-based sheet) may comprise an amorphous material (e.g., glass) and optionally one or more crystalline materials (e.g., ceramic). In some embodiments, a glass ribbon comprising an amorphous phase can be further processed into a glass-ceramic material. In one or more embodiments, a glass-based material may comprise, in mole percent (mol %): SiO₂ in a range from about 40 mol % to about 80%, A1₂O₃ in a range from about 10 mol % to about 30 mol %, B₂O₃ in a range from 0 mol % to about 10 mol %, ZrO₂ in a range from 0 mol% to about 5 mol %, P₂O₅ in a range from 0 mol % to about 15 mol %, TiO₂ in a range from 0 mol % to about 2 mol %, R₂O in a range from 0 mol % to about 20 mol %, and RO in a range from 0 mol % to about 15 mol %. As used herein, R₂O can refer to an alkali metal oxide, for example, Li₂O, Na₂O, K₂O, Rb₂O, and Cs₂O. As used herein, RO can refer to MgO, CaO, SrO, BaO, and ZnO. In some embodiments, a glass-based glass ribbon or glass sheet may optionally further comprise in a range from 0 mol % to about 2 mol % of each of Na₂SO₄, NaCl, NaF, NaBr, K₂SO₄, KC1, KF, KBr, As₂O₃, Sb₂O₃, SnO₂, Fe₂O₃, MnO, MnO₂, MnO₃, Mn₂O₃, Mn₃O₄, Mn₂O₇. “Glass-ceramics” include materials produced through controlled crystallization of glass. In some embodiments, glass-ceramics have about 1% to about 99% crystallinity. Examples of suitable glass-ceramics may include Li₂O—A1₂O₃—SiO₂ system (i.e. LAS-System) glass-ceramics, MgO—A1₂O₃—SiO₂ system (i.e. MAS-System) glass-ceramics, ZnO × A1₂O₃ × nSiO₂ (i.e. ZAS system), and/or glass-ceramics that include a predominant crystal phase including β-quartz solid solution, β-spodumene, cordierite, petalite, and/or lithium disilicate. The glass-ceramic ribbons or sheets may be strengthened using the strengthening processes described herein. In one or more embodiments, MAS-System glass-ceramic ribbons or sheets may be strengthened in Li₂SO₄ molten salt, whereby an exchange of 2Li⁺ for Mg²⁺ can occur.

The glass manufacturing apparatus 100 comprises a treatment apparatus 170. For example, as shown in FIGS. 3 and 5-6, the treatment apparatus 170 can comprise a first heating apparatus 215a and a second heating apparatus 215b with the draw plane 302 positioned between the first heating apparatus 215a and a second heating apparatus 215b. Although two heating apparatus 215a, 215b are shown as the treatment apparatus 170 are shown, a single heating apparatus or more than two heating apparatus may be provided in further embodiments. A discussion of features of the first heating apparatus 215a can apply equally to the second heating apparatus 215b unless indicated otherwise.

As shown in FIGS. 3 and 5-6, embodiments of the glass forming apparatus 101 comprising the treatment apparatus 170 comprising at least the first heating apparatus 215a can further comprise at least one heating element 303. As schematically shown in FIG. 3, the at least one heating element 303 of the first heating apparatus 215a can face the first major surface 103a of the ribbon of glass-forming material located downstream from the gap “G” and/or the orifice 208 along the draw direction 154. In some embodiments, the draw plane 302 can extend between the at least one heating element 303 of the first heating apparatus 215a and the at least one heating element 303 of the second heating apparatus 215b. In further embodiments, as shown, the at least one heating element 303 of the first heating apparatus 215a and the at least one heating element 303 of the second heating apparatus 215b can face one another and face in opposite directions so that the at least one heating element 303 of the first heating apparatus 215a can be configured to heat the first major surface 103a of the glass-forming ribbon and the at least one heating element 303 of the second heating apparatus 215b can impact a second major surface 103b of the glass-forming ribbon. As shown, the treatment apparatus 170 can be designed to heat both the first major surface 103a and the second major surface 103b although the treatment apparatus 170 may be designed to only heat one major surface in further embodiments. For example, the treatment apparatus 170 can be provided with the first heating apparatus 215a configured to heat the first major surface 103a without including a second heating apparatus 215b. In some embodiments, providing both the first heating apparatus 215a and the second heating apparatus 215b can help treat both the first major surface 103a and the second major surface 103b (e.g., simultaneously) in order treat both major surfaces and reduce the time for treatment of the major surfaces.

The at least one heating element 303 of the first heating apparatus 215a can be configured to emit energy 317 toward a location 315 on the first major surface 103a of the glass-forming ribbon. In some embodiments, the at least one heating element 303 of the second heating apparatus 215b can be configured to emit energy 321 towards a location 319 on the second major surface 103b of the glass-forming ribbon.

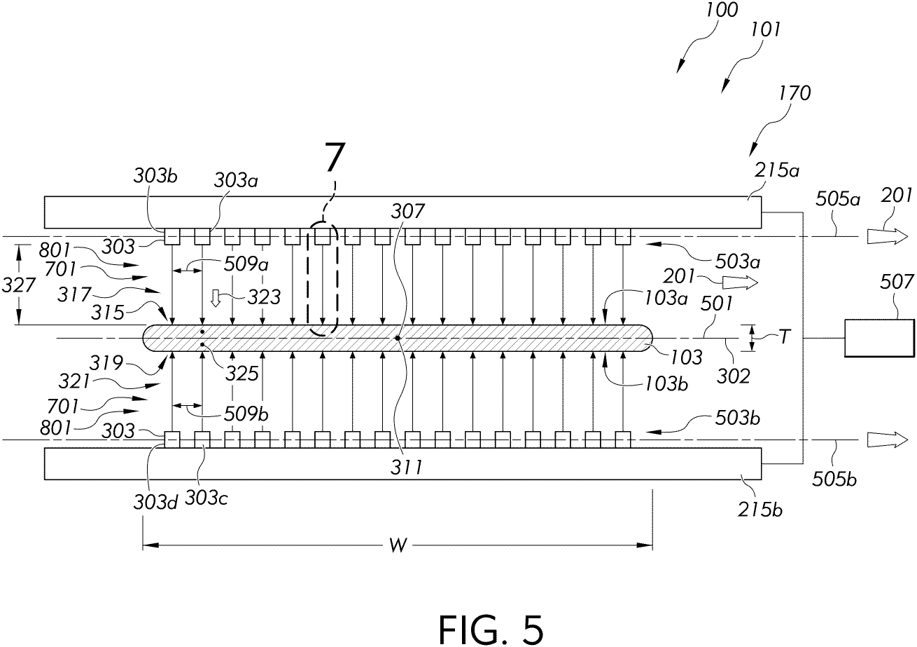

The at least one heating element 303 can comprise one or more heating elements. In some embodiments, referring to FIG. 5, the at least one heating element 303 of the first heating apparatus 215a can comprise a first plurality of heating elements 503a spaced along a first axis 505a and/or a second plurality of heating elements 503b spaced along a second axis 505b. In further embodiments, the first plurality of heating elements 503a of the first heating apparatus 215a and/or the second plurality of heating elements 503b of the second heating apparatus 215b may be spaced apart from one another along a single corresponding axis 505a, 505b although the first plurality of heating elements 503a and/or second plurality of heating elements 503b may be spaced apart along multiple axes and/or in a pattern in further embodiments. In further embodiments, a first spacing 509a can be defined between a first heating element 303a of the first plurality of heating elements 503a and a second heating element 303b of the first plurality of heating elements 503a that is adjacent to the first heating element 303a of the first plurality of heating elements 503a. In even further embodiments, the spacing between other pairs of adjacent heating elements of the first plurality of the heating elements 503a can be substantially equal (e.g., identical) to the first spacing 509a, although alternative spacings may be provided in further embodiments. In further embodiments, as shown, the first heating apparatus 215a can comprise the first plurality of heating elements 503a arranged in a row along the direction 201 of the width “W” of the glass-forming ribbon. In further embodiments, as shown, the first heating apparatus 215a can comprise the first plurality of heating elements 503a facing the first major surface 103a and the second heating apparatus 215b can comprise the second plurality of heating elements 503b facing the second major surface 103b.

In some embodiments, still referring to FIG. 5, the second plurality of heating elements 503b of the second heating apparatus 215b can be spaced along the second axis 505b. In further embodiments, a second spacing 509b can be defined between a first heating element 303c of the second plurality of heating elements 503b and a second heating element 303d of the second plurality of heating elements 503b that is adjacent to the first heating element 303c of the second plurality of heating elements 503b. In even further embodiments, the spacing between other pairs of adjacent heating elements of the second plurality of the heating elements 503b can be substantially equal (e.g., identical) to the second spacing 509b, although alternative spacings may be provided in further embodiments.

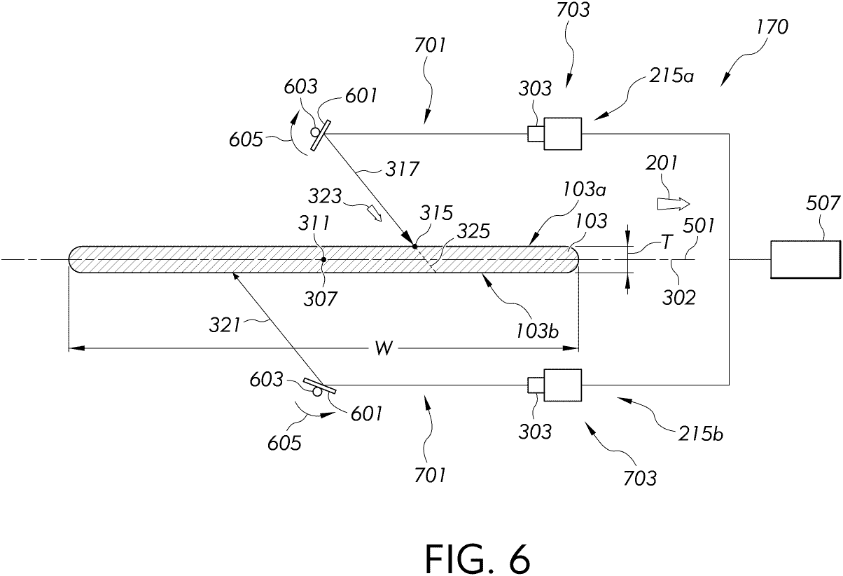

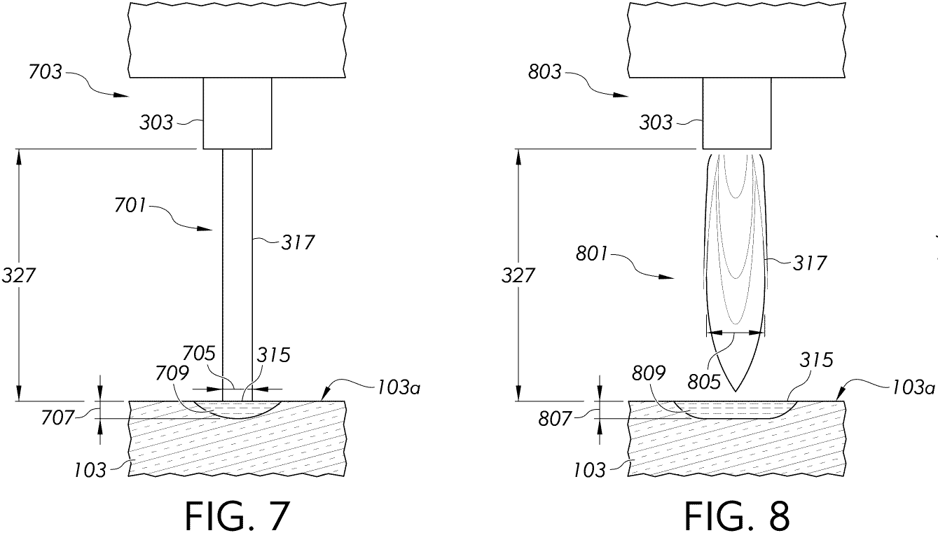

FIG. 7 shows an enlarged view of FIG. 5 according to some embodiments. In some embodiments, as shown in FIGS. 6-7, the at least one heating element 303 can comprise a laser 703. In further embodiments, the laser 703 can comprise a gas laser, a chemical laser, a solid-state laser, a Raman laser, and/or a quantum cascade laser. Example embodiments of gas lasers include helium-neon (HeNe), xenon, carbon dioxide (CO₂), carbon monoxide (CO), and nitrous oxide (N₂O). Example embodiments of chemical lasers include hydrogen fluoride (HF), deuterium fluoride (DF), chemical oxygen-iodine, and all gas phase iodine. Example embodiments of solid-state lasers include crystal lasers, fiber lasers, and laser diodes. Crystal-based lasers comprise a host crystal doped with a lanthanide, or a transition metal. Example embodiments of host crystals include yttrium aluminum garnet (YAG), yttrium lithium fluoride (YLF), yttrium othoaluminate (YAL), yttrium scandium gallium garnet (YSSG), lithium aluminum hexafluoride (LiSAF), lithium calcium aluminum hexafluoride (LiCAF), zinc selenium (ZnSe), ruby, forsterite, and sapphire. Example embodiments of dopants include neodymium (Nd), titanium (Ti), chromium (Cr), iron (Fe), erbium (Er), holmium (Ho), thulium (Tm), ytterbium (Yb), dysprosium (Dy), cerium (Ce), gadolinium (Gd), samarium (Sm), and terbium (Tb). Example embodiments of solid crystals include ruby, alexandrite, chromium fluoride, forsterite, lithium fluoride (LiF), sodium chloride (NaCl), potassium chloride (KC1), and rubidium chloride (RbCl). Laser diodes can comprise heterojunction or PIN diodes with three or more materials for the respective p-type, intrinsic, and n-type semiconductor layers. Example embodiments of laser diodes include AlGaInP, AlGaAs, InGaN, InGaAs, InGaAsP, InGaAsN, InGaAsNSb, GaInP, GaAlAs, GaInAsSb, and lead (Pb) salts. Some laser diodes can represent exemplary embodiments because of their size, tunable output power, and ability to operate at room temperature (i.e., about 20° C. to about 25° C.). Fiber lasers can comprise an optical fiber further comprising a cladding with any of the materials listed above for crystal lasers or laser diodes.

As shown in FIGS. 6-7, the heating element 303 comprising the laser 703 can be configured to emit energy comprising a laser beam 701 comprising a wavelength. The laser 703 may be operated such that the wavelength of the laser beam 701 is reduced by half (i.e., frequency doubled), reduced by two-thirds (i.e., frequency tripled), reduced by three-fourths (i.e., frequency quadrupled), or otherwise modified relative to a natural wavelength of a laser beam 701 produced by the laser 703. In some embodiments, the wavelength of the laser beam 701 may be about 1.5 micrometers (µm) or more, about 2.5 µm or more, about 3.5 µm or more, about 5 µm or more, about 9 µm or more, about 9.4 µm or more, about 20 µm or less, about 15 µm or less, about 12 µm or less, about 11 µm or less, or about 10.6 nm or less. In some embodiments, the wavelength of the laser beam 701 may be in a range from about 1.5 µm to about 20 µm, from about 1.5 µm to about 15 µm, from about 1.5 µm to about 12 µm, from about 1.5 µm to about 11 µm, from about 2.5 µm to about 20 µm, from about 2.5 µm to about 15 µm, from about 2.5 nm to about 12 µm, from about 3.6 µm to about 20 µm, from about 3.6 µm to about 15 µm, from about 3.6 µm to about 12 µm, from about 5 µm to about 20 µm, from about 5 µm to about 15 µm, from about 5 µm to about 12 µm, from about 5 µm to about 11 µm, from about 9 µm to about 20 µm, from about 9 µm to about 15 µm, from about 9 µm to about 12 µm, from about 9 µm to about 11 µm, from about 9 µm to about 1.6 µm, from about 9.4 µm to about 15 µm, from about 9.4 µm to about 12 µm, from about 9.4 µm to about 11 µm, from about 9.4 µm to about 10.6 µm, or any range or subrange therebetween. Exemplary embodiments of lasers capable of producing a laser beam 701 with a wavelength within the aforementioned ranges include a carbon dioxide (CO₂) laser and a nitrous oxide (N₂O) laser.

As shown in FIG. 5, in some embodiments, the first heating apparatus 215a can comprise a first plurality of heating elements 503a configured to emit a plurality of laser beams 701. In some embodiments, as shown, a plurality of lasers can be configured to emit the plurality of laser beams 701. In further embodiments, the number of lasers in the plurality of lasers can be equal to the number of laser beams in the plurality of laser beams. In further embodiments, the number of laser beams in the plurality of laser beams can be greater than the number of lasers in the plurality of lasers, for example, if one or more beam splitters are used to generate more than one laser beam from a laser. In some embodiments, a single laser optically coupled to one or more beam splitters can be configured to generate the plurality of lasers of the first heating apparatus. In some embodiments, as discussed above with regards to the first plurality of heating elements 503a in FIG. 5, the first heating apparatus 215a can be configured to emit a plurality of laser beams 701 arranged in a row along a direction 201 of the width “W” of the glass-forming ribbon. In further embodiments, the plurality of lasers of the first heating apparatus 215a can also be arranged in a row along a direction 201 of the width “W” of the glass-forming ribbon.

As shown in FIG. 6, in some embodiments, the first heating apparatus 215a can comprise a laser 703 configured to scan (e.g., move) a laser beam 701 across a portion of the first major surface 103a of the glass-forming ribbon. In further embodiments, as shown, the first heating apparatus 215a can further comprise a mirror 601 (e.g., mirror, polygonal mirror) that can be configured to reflect the laser beam 701 emitted from the laser 703 so that the laser beam 701 scans across a portion of the first major surface 103a of the glass-forming ribbon. In some embodiments, as shown, the mirror 601 is configured to be rotatable such that it can reflect the laser beam 701 emitted from the laser 703 and scan the laser beam 701 across a portion of the first major surface 103a of the glass-forming ribbon. In further embodiments, as shown, the mirror 601 can be rotable in at least a first direction 605 using a galvanometer 603. For example, rotating the mirror 601 with the galvanometer 603 in the first direction 605 may cause the laser beam 701 to scan across a portion of the first major surface 103a of the glass-forming ribbon in the direction 201 of the width “W” of the glass-forming ribbon. In even further embodiments, the galvanometer 603 can be configured to rotate in a second direction opposite the first direction 605 For example, rotating the mirror 601 with the galvanometer 603 in a second direction opposite the first direction 605 may cause the laser beam 701 to scan across the portion of the first major surface 103a of the glass-forming ribbon opposite the direction 201 of the width “W” of the glass-forming ribbon. In still further embodiments, the galvanometer 603 can be configured to alternate between rotating in a first direction 605 and rotating in a second direction opposite the first direction 605. In further embodiments, the mirror 601 can comprise a polygonal mirror. The polygonal mirror can comprise a plurality of reflective surfaces and may be rotated by a motor (e.g., galvanometer 603) in a first direction 605. For example, rotating the polygonal mirror with the motor in the first direction 605 may cause the laser beam 701 to scan across a portion of the first major surface 103a of the glass-forming ribbon in a direction 201 of the width “W” of the glass-forming ribbon. In some embodiments, the portion of first major surface 103a of the glass-forming ribbon, as a percentage of the width “W” of the glass-forming ribbon, scanned by the laser beam 701 can be about 66% or more, about 80% or more, about 90% or more, about 95% or more, 100% or less, about 98% or less, or about 95% or less. In further embodiments, the portion of the first major surface 103a of the glass-forming ribbon, as a percentage of the width “W” of the glass-forming ribbon, scanned by the laser beam 701 can be in a range from about 66% to 100%, from about 80% to 100%, from about 90% to 100%, from about 95% to 100%, from about 66% to about 98%, from about 80% to about 98%, from about 90% to about 98%, from about 95% to about 98%, from about 66% to about 95%, from about 80% to about 95%, from about 85% to about 95%, from about 85% to about 90%, or any range or subrange therebetween.

In some embodiments, as shown in FIG. 8, the at least one heating element 303 can comprise a burner 803. The burner can be configured to emit fuel that can be ignited to form a flame 801. In some embodiments, the fuel can be a gas, for example, methane. In some embodiments, the fuel can comprise solid particles. In some embodiments, the fuel can comprise a liquid. The fuel can comprise one or more components. Exemplary embodiments of fuel components comprise alkanes, alkenes, alkynes (e.g., acetylene, propyne), alcohols, hydrazine or a hydrazine-derivative, and oxidizers. Example embodiments of alkanes include methane, ethane, propane, butane, pentane, hexane, heptane, and octane. Exemplary embodiments of alkenes include ethylene, propylene, and butylene. Exemplary embodiments of alcohols include methanol, ethanol, propanol, butanol, hexanol, and octanol. Exemplary embodiments of oxidizers include oxygen, nitrogen oxides (e.g., NO₂, N₂O₄), peroxides (e.g., H₂O₂), perchlorates (e.g., ammonia perchlorate). Although not shown, the burner 803 can be in fluid communication with a fuel source, for example, a cannister, a cartridge, and/or a pressure vessel. In some embodiments, the burner can comprise a nozzle comprising a polygonal (e.g., triangular, quadrilateral, pentagonal, hexagonal, etc.) cross-section, a rounded (e.g., elliptical, circular) cross-section, or a curvilinear cross-section. In some embodiments, the flame 801 can be configured to emit light comprising a spectral distribution. Without wishing to be bound by theory, the spectral distribution of the flame comprising a temperature can substantially correspond to a spectral spectrum of a black body comprising the temperature. In further embodiments, the spectral distribution can be controlled by adjusting the fuel type, oxygen ratio, and/or flame temperature.

As shown in FIG. 5, in some embodiments, the first heating apparatus 215a can comprise a first plurality of heating elements 503a configured to emit a plurality of flames 801. In some embodiments, as shown, a plurality of burners can be configured to emit the plurality of flames 801. In some embodiments, as discussed above with regards to the first plurality of heating elements 503a in FIG. 5, the first heating apparatus 215a can be configured to emit a plurality of flames 801 arranged in a row along a direction 201 of the width “W” of the glass-forming ribbon. In further embodiments, the plurality of flames of the first heating apparatus 215a can also be arranged in a row along a direction 201 of the width “W” of the glass-forming ribbon.

In some embodiments, as shown in FIGS. 5-6, the heating apparatus (e.g., one or more heating elements) may optionally be operated by a control device 507 (e.g., programmable logic controller) configured to (e.g., “programmed to”, “encoded to”, “designed to”, and/or “made to”) send command signals along communication line to the heating apparatus 215a, 215b. In further embodiments, the control device 507 can send signals controlling the intensity (e.g., power, fluence) of the thermal energy emitted from the one or more heating elements 303. In even further embodiments, the one or more heating elements can comprise more than one heating element, where a first heating element can be controlled by the control device 507 independent of a second heating element. In even further embodiments, the one or more heating elements 303 can comprise one or more lasers and the control device 507 can control the wavelength of the laser beam emitted from the one or more lasers and/or a duty cycle (e.g., pulse width, time between pulses, or continuous wave) of the one or more lasers. In further embodiments, the one or more heating elements 303 can comprise one or more burners and the control device 507 can control one or more of a mass flow rate of the fuel, an oxygen ratio, a rate of energy emitted, and/or a spectral distribution emitted from the flame emitted from the one or more burners. In further embodiments, as shown in FIG. 6, the heating apparatus 215a, 215b can comprise a mirror 601 (e.g., polygonal mirror) configured to be rotated using a galvanometer 603 or other motor, and the control device 507 can control one or more of a position of the mirror 601, a rotation speed of the galvanometer 603, and/or a rotation direction of the galvanometer 603. In even further embodiments, the control device 507 can cause the mirror 601 to rotate at a substantially constant angular velocity.

Methods of manufacturing a glass ribbon 103 from a quantity of glass-forming material 121 will now be described. Referring to FIG. 2, the inlet conduit 141 can supply the quantity of glass-forming material 121 to the glass forming apparatus 101. The quantity of glass-forming material 121 can pass through a delivery conduit 206 and through the outlet port 207. The quantity of glass-forming material 121 can optionally be delivered to the pair of forming rollers 210. For instance, as shown in FIG. 2, the orifice 208 to cause the quantity of glass-forming material 121 to flow downwardly from the outlet port 207 and spread into an elongated stream of glass-forming material 121 extending across the travel path 311 (e.g., along the length “L” of the pair of forming rollers 210). In some embodiments, the glass-forming material can flow through the orifice 208 of the forming device 140. In further embodiments, the orifice 208 can introduce a roughness to a surface of the glass ribbon formed by the orifice 208. For example, the orifice can provide a glass ribbon substantially with a uniform thickness while still introducing roughness to the surface of the glass ribbon as a result of wear of the orifice.

Alternatively, as shown in FIG. 2, in some embodiments, the outlet port 207 can deliver the stream (e.g., circular stream, elliptical stream, etc.) of glass-forming material 121 to the pair of forming rollers 210. As shown in FIGS. 2-4, a pool 209 of the glass-forming material 121 may form upstream from the minimum distance “D” between the outer peripheral surfaces 213a, 213b of the forming rollers 210a, 210b relative to the draw direction 154. The pool 209 of glass-forming material 121 can provide an accumulation zone of material to help provide an adequate supply of glass-forming material 121 along the length “L” of the pair of forming rollers 210 to provide a roller-formed glass-forming ribbon that can be cooled to produce a glass ribbon 103 of substantially uniform thickness along a width “W” of the glass ribbon 103. In some embodiments, as shown in FIG. 4, the first forming roller 210a and/or the second forming roller 210b can contact the corresponding major surface (e.g., first major surface 103a, second major surface 103b) of the glass-forming ribbon across substantially the entire width “W” of the glass-forming ribbon. While not shown, in some embodiments, only one roller can be provided, and the roller can contact the first major surface of the glass-forming ribbon across substantially the entire width of the glass-forming ribbon. However, the pair of forming rollers 210 can introduce a roughness to a surface of the ribbon formed by the pair of forming rollers 210. For example, the pair of forming rollers can provide a ribbon substantially uniform thickness while still introducing roughness to the surface of the ribbon as a result of wear of the rollers.

Methods can further include the step of roller-forming the glass-forming ribbon from the quantity of glass-forming material 121 with the pair of rotating forming rollers 210. For example, with reference to FIG. 3, the first forming roller 210a can rotate about the first axis 211a in the illustrated inward rotation direction 212a such that the velocity vector of the point of tangency along line 301a extends in the draw direction 154. Likewise, the second forming roller 210b can rotate about the second axis 211b in the illustrated inward rotation direction 212b, opposite the inward rotation direction 212a of the first forming roller 210a, such that the velocity vector at the point of tangency along line 301b also extends in the draw direction 154. As shown, in some embodiments, each forming roller 210a, 210b can optionally be identical to one another and rotate along corresponding rotation directions 212a, 212b at substantially identical speeds. Due to the inward rotation directions 212a, 212b, the quantity of glass-forming material 121 is roll-formed into the ribbon of glass-forming material as the quantity of glass-forming material 121 is pressed through the gap “G”. Although not shown, in some embodiments, one or both forming rollers 210a, 210b may be internally cooled to provide an initial level of cooling of the ribbon of glass-forming material passing through the gap “G”. Furthermore, as indicated by arrows 313a, 313b, one or both of the forming rollers 210a, 210b may be movable to adjust the initial thickness of the ribbon of molten material passing through the gap “G”.

After roller-forming the glass-forming ribbon from the quantity of glass-forming material 121 with the pair of rotating forming rollers 210, the thickness of the glass-forming ribbon can be reduced as it is being pulled from the gap “G”. For example, with reference to FIGS. 2-3, gravity can act on the mass of the glass-forming ribbon hanging below the pair of forming rollers 210 to stretch the glass-forming ribbon and thereby thin the glass-forming ribbon to its final thickness “T” reached in the elastic zone. In addition to gravity, in some embodiments, further pulling can be achieved by optional edge pull rollers to provide the desired thickness. For example, although not shown, a pair of inclined rollers that are each downwardly inclined in the draw direction can be provided at opposite edge portions of the glass-forming ribbon. In some embodiments, these inclined edge rollers can be provided to provide cross tension in the glass-forming ribbon as well as pulling of the glass-forming ribbon in the draw direction. In addition, or alternatively, although not shown, a pair of horizontal edge rollers may be provided. The horizontal edge rollers can have rotational axes that are perpendicular to the draw direction. Such horizontal edge rollers can be provided at each edge portion of the glass-forming ribbon to likewise provide further pulling of the glass-forming ribbon to further thin the glass-forming ribbon. The inclined edge rollers and/or horizontal edge rollers, if provided, can be arranged to contact the corresponding portions of the glass-forming ribbon within the visco-elastic or elastic region of the glass-forming ribbon. Furthermore, although not shown, the inclined edge rollers can be positioned downstream from the horizontal edge rollers although the horizontal edge rollers may be located downstream from the inclined edge rollers in further embodiments.

Methods can comprise heating a first major surface 103a of the glass-forming ribbon using the treatment apparatus 170 while the glass-forming ribbon is traveling along the travel path 311 in the draw direction 154. As shown in FIGS. 2-6, the treatment apparatus 170 can comprise a first heating apparatus 215a configured to heat the first major surface 103a. In some embodiments, as shown, the treatment apparatus 170 can further comprise a second heating apparatus 215b configured to heat the second major surface 103b. As shown in FIGS. 3 and 5-6, the first heating apparatus 215a comprising one or more heating elements 303 that can heat the first major surface 103a by emitting energy 317 to impinge a location 315 on the first major surface 103a of the glass-forming ribbon at the target location 307 and the location 315 itself. Throughout the disclosure, the target location 307 is defined as a location on the travel path 311 impinged by an extended path 325 of the energy 317 emitted from the one or more heating elements 303. As used herein, an extended path of the energy emitted from the one or more heating elements is a line extending a direction that the energy was heading when it was within 10 millimeters (mm) of the corresponding major surface of the glass-forming ribbon at a corresponding location where the direction was determined. It is to be understood that a location on a major surface of the glass-forming is impinged by the energy if the extended path impinges that location. For example, with reference to FIG. 3, the energy 317 emitted from the one or more heating elements 303 of the first heating apparatus 215a can impinge the location 315 on the first major surface 103a and the target location 307 because the extended path 325 impinges the location 315, where the extended path 325 includes a location of the energy 317 within 10 mm of the first major surface 103a and extends in a direction 323 that the energy 317 is travelling in a direction 323 that the energy 317 was heading when it was within 10 mm of the first major surface 103a will impinge the location 315 on the first major surface 103a and the target location 307. It is to be understood that the target location 307 on the travel path 311 is impinged if the extended path 325 impinges a line comprising the target location 307 extending in a direction 201 of the width “W”. For example, with reference to FIG. 5, the first heating element 303a can emit a first energy 317a that impinges the target location 307 of the travel path 311 since the extended path 325 impinges a line 501 comprising the target location 307 of the travel path 311 and extending in the direction 201 of the width “W”. As shown in FIGS. 5-6, in some embodiments, the draw plane 302 can comprise the line 501 comprising the target location 307 of the travel path 311.

In some embodiments, before heating the glass-forming ribbon with the energy 317, 321, the glass-forming ribbon at the target location 307 of the travel path 311 can be in a viscous or viscoelastic state. Before heating the glass-forming ribbon, the glass-forming ribbon can comprise an average temperature at the target location of the travel path. As used herein, the average temperature can be measured using ASTM E1256-17 or ASTM E2758-15, for example, using an Optris PI 640 infrared camera. In some embodiments, the average temperature of the glass-forming ribbon at the target location before the heating can be about 500° C. or more, about 600° C. or more, about 750° C. or more, about 900° C. or more, about 1100° C. or more, about 1300° C. or less, about 1250° C. or less, about 1100° C. or less, about 750° C. or less, or about 700° C. or less. In some embodiments, the average temperature of the glass-forming ribbon at the target location before the heating can be in a range from about 500° C. to about 1300° C., from about 600° C. to about 1300° C., from about 750° C. to about 1300° C., from about 900° C. to about 1300° C., from about 1100° C. to about 1300° C., from about 750° C. to about 1250° C., from about 900° C. to about 1250° C., from about 1100° C. to about 1250° C., from about 900° C. to about 1100° C., or any range or subrange therebetween. In further embodiments, the average temperature of the glass-forming ribbon at the target location before the heating can be in a range from about 500° C. to about 750° C., from about 500° C. to about 700° C., from about 600° C. to about 750° C., from about 600° C. to about 700° C., or any range or subrange therebetween. Providing the glass-forming ribbon with an average temperature within one or more of the above-mentioned ranges before the heating can produce a glass ribbon and/or glass-sheet with low or no residual stress from the heating.

Before heating the glass-forming ribbon, the glass-forming ribbon can comprise an average viscosity at the target location of the travel path. As used herein, the average viscosity can be measured using ASTM C965-96(2017) when the glass-forming material is above the softening point or using ASTM C1351M-96(2017) when the glass-forming material is below the softening point. For example, the viscosity can be determined by measuring the viscosity using one of the above-mentioned ASTM standards when a sample of the glass-forming material is heating to the average temperature of the glass-forming material at the target location, as described above. In some embodiments, the average viscosity of the glass-forming ribbon at the target location before the heating can be about 1,000 Pascal-seconds (Pa-s) or more, about 10,000 Pa-s or more, about 50,000 Pa-s or more, about 10⁵ Pa-s or more, about 10⁵ Pa-s or more, about 10^{6.6} Pa-s or more, about 10⁸ Pa-s or more, about 10¹¹ Pa-s or less, about 10⁹ Pa-s or less, about 10^{6.6} Pa-s or less, about 10⁵ Pa-s or less, about 50,000 Pa-s or less, about 20,000 Pa-s or less, or about 15,000 Pa-s or less. In some embodiments, the average viscosity of the glass-forming ribbon at the target location before the heating can be in a range from about 1,000 Pa-s to about 10¹¹ Pa-s, from about 10,000 Pa-s or more to about 10¹¹ Pa-s, from about 50,000 Pa-s to about 10¹¹ Pa-s, from about 10⁵ Pa-s to about 10¹¹ Pa-s, from about 10^{6.6} Pa-s to about 10¹¹ Pa-s, from about 10⁸ to about 10¹¹ Pa-s, from about 10^{6.6} Pa-s to about 10⁹ Pa-s, from about 10⁸ Pa-s to about 10⁹ Pa-s, or any range or subrange therebetween. In further embodiments, the average viscosity of the glass-forming ribbon at the target location before the heating can be in a range from about 1,000 Pa-s to about 10^{6.6} Pa-s, from about 10,000 Pa-s to about 10^{6.6} Pa-s, from about 50,000 Pa-s to about 10^{6.6} Pa-s, from about 10⁵ Pa-s to about 10^{6.6} Pa-s, from about 1,000 Pa-s to about 10⁵ Pa-s, from about 10,000 Pa-s to about 10⁵ Pa-s, from about 50,000 to about 10⁵ Pa-s, from about 1,000 Pa-s to about 50,000 Pa-s, from about 10,000 Pa-s to about 50,000, from about 1,000 Pa-s to about 20,000 Pa-s, from about 10,000 Pa-s to about 20,000 Pa-s, from about 10,000 Pa-s to about 15,000 Pa-s, or any range or subrange therebetween. Providing the glass-forming ribbon with an average viscosity within one or more of the above-mentioned ranges before the heating can produce a glass ribbon and/or glass-sheet with low or no residual stress from the heating.

In some embodiments, as shown in FIGS. 3, 5, and 7-8, a minimum distance 327 between the one or more heating elements 303 of the first heating apparatus 215a and the first major surface 103a at the target location 307 can be about 10 mm or more, about 50 mm, or more, about 100 mm or more, about 5 meters (m) or less, about 1 m or less, or about 200 mm or less. In some embodiments, the minimum distance 327 can be in a range from about 10 mm to about 5 m, from about 10 mm to about 1 m, from about 10 mm to about 200 mm, from about 50 mm to about 5 m, from about 50 mm to about 1 m, from about 50 mm to about 200 mm, from about 100 mm to about 5 m, from about 100 mm to about 1 m, from about 100 mm to about 200 mm, or any range or subrange therebetween. In further embodiments, as shown in FIG. 5, a minimum distance 327 between a first heating element 303a of the one or more heating elements 303 (e.g., first plurality of heating elements 503a) and the first major surface 103a at the target location 307 can be substantially equal to a minimum distance between a second heating element 303b of the one or more heating elements 303 (e.g., first plurality of heating elements 503a) and the first major surface 103a at the target location 307.

In some embodiments, the glass-forming material 121 comprising the glass-forming ribbon at the target location 307 can comprise an absorption depth for the energy 317 emitted from the one or more heating elements 303. Throughout the disclosure, an absorption depth of the glass-forming material at a first wavelength is defined as a thickness of the material at which an intensity (e.g., power, fluence) of energy comprising the first wavelength to decrease to 36.8% (i.e., 1/e) of an initial intensity of the energy comprising the first wavelength. Without wishing to be bound by theory, it is possible to estimate the absorption depth using the Beer-Lambert law, which predicts that intensity decreases exponentially with the thickness of the material divided by the absorption depth. For some materials, the absorption depth may change with temperature. Accordingly, the absorption depth is measured when the glass-forming material 121 is at the average temperature of the glass-forming ribbon at the target location 307. For example, the absorption depth of the glass-forming material can be measured at about 1000° C. (e.g., if the average temperature of the glass-forming ribbon is about 1000° C. at the target location). For example, the one or more heating elements 303 can comprise a laser 703 configured to emit a laser beam 701 substantially comprises a first wavelength, and the absorption depth of glass-forming material for the energy 317 emitted by the laser comprising the laser beam 701 can be the absorption depth of the glass-forming material at the average temperature of the glass-forming ribbon at the target location to the first wavelength.

The intensity (e.g., power, fluence) of one or more wavelengths comprising the energy 317 emitted from the one or more heating elements 303 can be measured using a spectrum analyzer, for example, an OSA207C spectrometer available from ThorLabs. In some embodiments, the energy 317 emitted from the one or more heating elements 303 can comprise substantially one wavelength (e.g., about 90% or more of the energy comprises the one wavelength) or entirely comprise one wavelength, for example, when the one or more heating elements 303 comprises a laser 703. In some embodiments, the energy 317 emitted from the one or more heating elements 303 can comprise more than one wavelength with significant intensity (e.g., more than one wavelength comprising about 5% or more of the energy), for example, when the one or more heating elements 303 comprises a burner 803. As used herein, the absorption depth of the glass-forming material of energy comprising multiple wavelengths is defined as the weighted average of the absorption depth at each wavelength weighted by the percentage of the energy’s intensity comprising the corresponding wavelength. For example, the one or more heating elements can 303 can comprise a burner 803 configured to emit a flame 801 that can emit light comprising a first spectral distribution. The absorption depth of the glass forming material for the energy 317 emitted by the burner 803 can be a weighted average of the absorption depth of the glass-forming material at the target location at each wavelength of the first spectral distribution weighted by the percentage of the energy’s intensity comprising the corresponding wavelength of the first spectral distribution. Without wishing to be bound by theory, non-light energy transferred from the flame to the glass-forming ribbon (e.g., by conduction and/or convection) can be absorbed substantially within less than 1 µm from the corresponding surface and thus does not significantly impact the absorption depth of a total energy transmitted from the flame.

In some embodiments, the glass-forming material 121 may comprise an absorption depth for the energy 317 of about 50 micrometers (µm) or less, about 30 µm or less, about 20 µm or less, about 10 µm or less, about 8 µm or less, about 5 µm or less, about 0.1 µm or more, about 1 µm or more, about 5 µm or more, or about 8 µm or more. In some embodiments, the glass-forming material 121 may comprise an absorption depth for the energy 317 in a range from about 0.1 µm to about 50 µm, from about 0.1 µm to about 30 µm, from about 0.1 µm to about 20 µm, from about 0.1 µm to about 10 µm, from about 0.1 µm to about 8 µm, from about 0.1 µm to about 5 µm, from about 1 µm to about 50 µm, from about 1 µm to about 30 µm, from about 1 µm to about 10 µm, from about 1 µm to about 10 µm, from about 1 µm to about 8 µm, from about 1 µm to about 5 µm, from about 5 µm to about 50 µm, from about 5 µm to about 30 µm, from about 5 µm to about 10 µm, from about 5 µm to about 8 µm, from about 8 µm to about 50 µm, from about 8 µm to about 50 µm, from about 8 µm to about 20 µm, from about 8 µm to about 10 µm, or any range or subrange therebetween. Providing one or more heating elements configured to emit energy such that an absorption depth of the glass-forming material for the energy is small (e.g., about 50 µm or less, about 10 µm or less) can enable a reduction of the surface roughness of the glass-forming ribbon at the first major surface without substantially changing the thickness of the glass-forming ribbon, without deforming the bulk of the glass-forming ribbon, and without substantially heating the rest of the glass-forming ribbon at the target location.

In some embodiments, the glass-forming material may comprise a thermal diffusivity. Throughout the disclosure, the thermal diffusivity of the glass-forming material can be measured using ASTM E1461-13. For some materials, the thermal diffusivity may change with temperature. Accordingly, the thermal diffusivity is measured when the glass-forming material is at the average temperature of the glass-forming ribbon at the target location. For example, the thermal diffusivity of the glass-forming material can be measured at about 1000° C. (e.g., if the average temperature of the glass-forming ribbon is about 1000° C. at the target location).

Throughout the disclosure, a width of the energy 317 impinging on a portion of glass-forming ribbon is defined as the distance in a direction across the travel path 311 (i.e., perpendicular to the draw direction 154 and parallel to a draw plane 302) between a first point on the first major surface 103a of the glass-forming ribbon impinged by the energy 317 and a second point on the first major surface 103a of the glass-forming ribbon impinged by the energy 317 with an intensity of about 13.5 % (i.e., 1/e²) of a maximum intensity of the energy 317 at the location 315 of the first major surface 103a of the glass-forming ribbon at the target location 307, where the first point and the second point are as far apart as possible in the direction across the travel path 311. In some embodiments, as shown in FIG. 7, the one or more heating elements 303 can comprise a laser 703 that emits a laser beam 701 that impinges the first major surface 103a of the glass-forming ribbon with a width 705. In some embodiments, as shown in FIG. 8, the one or more heating elements 303 can comprise a burner 803 that emits a flame 801. In even further embodiments, the flame 801 can emit light comprising the spectral distribution that impinges the first major surface 103a of the glass-forming ribbon with a width 805. Without wishing to be bound by theory, the flame 801 may emit light isotropically; however, the intensity (e.g., power, fluence) of the light impinging a major surface of the glass-forming ribbon can be peaked at a location corresponding to where the extended path 325 impinges the surface (e.g., target location). For example, target location can correspond to the closest point on the surface to the flame 801 and/or burner 803, and the intensity of the light emitted from the flame measured at the surface can be at a maximum at the target location. Without wishing to be bound by theory, a power density from a point source of radiation can decrease as the distance from the point source increases proportional to the inverse square of the distance. Without wishing to be bound by theory, the width of the flame can be about pi or less times a minimum distance 327 (see FIGS. 3, 5, 7-8) between the burner and the target location 307.

In some embodiments, the maximum width of the energy 317 (e.g., laser beam, light emitted from a flame) as a percentage of the width “W” of the glass-forming ribbon can be about 30% or more, about 50% or more, about 66% or more, about 80% or more, about 90% or more, 100% or less, about 98% or less, about 95% or less, about 90% or less, or about 80% or less. In some embodiments, the maximum width of the energy 317 (e.g., laser, beam, light emitted from a flame) as a percentage of the width “W” of the glass-forming ribbon can be in a range from about 30% to 100%, from about 30% to about 98%, from about 30% to about 95%, from about 30% to about 90%, from about 50% to 100%, from about 50% to about 98%, from about 50% to about 95%, from about 50% to about 90%, from about 66% to 100%, from about 66% to about 98%, from about 66% to about 95%, from about 66% to about 90%, from about 80% to 100%, from about 80% to about 98%, from about 80% to about 95%, from about 80% to about 90%, from about 90% to 100%, from about 90% to about 98%, from about 90% to about 95%, or any range or subrange therebetween. In some embodiments, the maximum width of the energy 317 can be about 100 µm or more, about 200 µm or more, about 500 µm or more, about 1 mm or more, about 2 mm or more, about 5 mm or more, about 10 mm or more, about 30 mm or less, about 20 mm or less, or about 15 mm or less. In some embodiments, the maximum width of the energy 317 can be in a range from about 100 µm to about 30 mm, from about 100 µm to about 20 mm, from about 100 µm to about 15 mm, from about 200 µm to about 30 mm, from about 200 µm to about 20 mm, from about 200 µm to about 15 mm, from about 500 µm to about 30 mm, from about 500 µm to about 20 mm, from about 500 µm to about 15 mm, from about 1 mm to about 30 mm, from about 1 mm to about 20 mm, from about 1 mm to about 15 mm, from about 2 mm to about 30 mm, from about 2 mm to about 20 mm, from about 2 mm to about 15 mm, from about 5 mm to about 30 mm, from about 5 mm to about 20 mm, from about 5 mm to about 15 mm, from about 10 mm to about 30 mm, from about 10 mm to about 20 mm, or from about 15 mm to about 20 mm.

Throughout the disclosure an area of the glass-forming ribbon impinged by the energy 317 is defined as a portion of the glass-forming ribbon impinged by the energy 317 with an intensity of about 13.5 % (i.e., 1/e²) of a maximum intensity of the energy 317, where the area is measured at the surface of the glass-forming ribbon closest to the one or more heating elements 303 (e.g., the first major surface 103a).

The one or more heating elements 303 of the first heating apparatus 215a can emit energy at a specified rate (i.e., power). Throughout the disclosure, the “power” is the average power emitted from the one or more heating elements 303 as measured using a thermopile. In some embodiments, the power emitted can be controlled by adjusting the parameters of the one or more heating elements. For example, the one or more heating elements can comprise a laser, and the adjustable parameters can comprise one or more of electrical current or voltage, optical pumping conditions, and optics. In some embodiments, the one or more heating elements can comprise a burner, and the adjustable parameters can comprise one or more of a fuel composition, a feed rate of the fuel, an oxygen ratio, and burner configuration. Throughout the disclosure, a fluence is the power emitted by the one or more heating elements divided by the area of the portion of the glass-forming ribbon impinged by the energy emitted from the one or more heating elements, as defined above. In some embodiments, the rate of energy emitted from the one or more heating elements that is transferred to the area of the glass-forming ribbon (i.e., fluence) can be about 0.1 kilowatts/centimeter² (W/cm²) or more, about 1 kW/cm² or more, about 5 kW/cm² or more, about 10 kW/cm² or more, about 20 kW/cm² or more, about 100 kW/cm² or less, about 60 kW/cm² or less, about 40 kW/cm² or less, about 20 kW/cm² or less, or about 10 kW/cm² or less. In some embodiments, the rate of energy emitted from the one or more heating elements that is transferred to the area of the glass-forming ribbon (i.e., fluence) can be in a range from about 0.1 kW/cm² to about 100 kW/cm², from about 1 W/cm² to about 100 kW/cm², from about 5 kW/cm² to about 100 kW/cm², from about 10 kW/cm² to about 100 kW/cm², from about 20 kW/cm² to about 100 kW/cm², from about 0.1 kW/cm² to about 60 kW/cm², from about 1 kW/cm² to about 60 kW/cm², from about 5 kW/cm² to about 60 kW/cm², from about 10 kW/cm² to about 60 kW/cm², from about 20 kW/cm² to about 60 kW/cm², from about 0.1 kW/cm² to about 40 kW/cm², from about 1 kW/cm² to about 40 kW/cm², from about 5 kW/cm² to about 40 kW/cm², from about 10 kW/cm² to about 40 kW/cm², from about 20 kW/cm² to about 40 kW/cm², from about 0.1 kW/cm² to about 20 kW/cm², from about 1 kW/cm² to about 20 kW/cm², from about 5 kW/cm² to about 20 kW/cm², from about 10 kW/cm² to about 20 kW/cm², or any range or subrange therebetween. Providing a fluence and/or intensity within one or more of the above-mentioned ranges can prevent ablation will providing enough heating to reduce the surface roughness of the glass-forming ribbon. In some embodiments, substantially all of the energy transferred to the glass-forming ribbon at the target location can be within one or more of the above-mentioned ranges for the absorption depth.

In some embodiments, as shown in FIG. 7, the one or more heating elements 303 can comprise a laser 703 that emits a laser beam 701 that impinges the first major surface 103a of the glass-forming ribbon at the target location 307 (see FIG. 5). The laser can comprise any one or more of the lasers discussed above. Likewise, the wavelength of the laser beam emitted from the laser can be within one or more of the ranges discussed above for the wavelength of the laser beam. As shown, the laser beam 701 can comprise a width 705 on the first major surface 103a impinged by the laser beam 701. The width of the laser beam can be within one or more of the ranges discussed above for the width of the energy. In some embodiments, as shown in FIG. 6, methods can comprise scanning the laser beam 701 across a portion of the width “W” of the glass-forming ribbon at the target location 307, and the portion scanned can be within one or more of the ranges discussed above for the portion scanned. In some embodiments, as shown in FIG. 5, emitting the laser beam 701 can comprise emitting a plurality of laser beams that impinge the first major surface 103a of the glass-forming ribbon at the target location 307. In further embodiments, the plurality of lasers emitting the plurality of laser beams 701 can be arranged in a row along a direction 201 of the width “W” of the glass-forming ribbon. In some embodiments, the laser 703 can emit a laser beam 701 comprising a substantially constant fluence. In further embodiments, the laser 703 can substantially continuously emit a laser beam 701 of substantially constant fluence. For example, the laser 703 may be operated as a continuous wave (CW) laser. For example, the laser 703 may be operated as a pulsed laser with about 1 second or less between pulses.

In some embodiments, as shown in FIG. 8, the one or more heating elements 303 can comprise a burner 803 that emits a flame 801. In further embodiments, the flame 801 can emit light comprising a spectral distribution that can impinge the first major surface 103a of the glass-forming ribbon at the target location 307 (see FIG. 5). The flame 801 can comprise a width 805 on the first major surface 103a impinged by the flame 801. As discussed above, the width 805 can be measured in a direction transverse (e.g., perpendicular) to the draw direction along the first major surface of a region with an intensity (e.g., power, fluence) of about 13.5 % (i.e., 1/e²) of a maximum intensity of the light emitted from the flame impinging the location 315 of the first major surface 103a of the glass-forming ribbon at the target location 307. Without wishing to be bound by theory, the flame 801 may emit light isotropically; however, the intensity (e.g., power, fluence) of the light impinging a major surface of the glass-forming ribbon can be peaked at a location corresponding to where the extended path 325 impinges the surface (e.g., target location). For example, target location can correspond to the closest point on the surface to the flame 801 and/or burner 803, and the intensity of the light emitted from the flame measured at the surface can be at a maximum at the target location. Without wishing to be bound by theory, a power density from a point source of radiation can decrease as the distance from the point source increases proportional to the inverse square of the distance. Without wishing to be bound by theory, the width of the flame can be about pi or less times a minimum distance 327 (see FIGS. 3, 5, 7-8) between the burner and the target location 307. The width of the flame can be within one or more of the ranges discussed above for the width of the energy. In further embodiments, the flame 801 can heat the glass-forming ribbon without touching the first major surface of the glass forming ribbon, which can, for example, limit soot deposits on the first major surface from the flame 801. In some embodiments, as shown in FIG. 5, emitting the flame 801 can comprise emitting a plurality of flames that impinged the first major surface 103a of the glass-forming ribbon at the target location 307. In further embodiments, the plurality of burners emitting the plurality of flames 801 can be arranged in a row along a direction 201 of the width “W” of the glass-forming ribbon. In some embodiments, the burner 803 can emit a flame 801 of substantially constant power.

Throughout the disclosure, a residence time of the energy emitted from the one or more heating elements at a location on the glass-forming ribbon is defined as a total time that the location on the glass-forming ribbon is within the area (defined above) impinged by the energy. With reference to FIG. 3, the residence time of the energy 317 emitted from the one or more heating elements 303 at the location 315 on the first major surface 103a of the glass-forming ribbon is the time that the glass-forming material at the location 315 on the first major surface 103a is within the area on the first major surface 103a impinged by the energy 317 emitted from the one or more heating elements 303. For example, the residence time of the glass-forming material at the location 315 impinged by stationary (e.g., non-scanning) laser beam 701 can be equal to the time that the location 315 is within the area impinged by the laser beam 701 (e.g., as the glass-forming material moves in the draw direction 154 from above the area to within the area and then from within the area to below the area). For example, the residence time of the glass-forming material at the location 315 impinged by a scanning laser beam 701 can be equal to the sum of the times that the glass-forming material was within the area impinged by the laser beam 701 (e.g., each time that area of the laser beam scanned across the glass-forming material as the glass-forming material travelled in the draw direction 154). In some embodiments, as shown in FIG. 3, the residence time can be controlled (e.g., adjusted, limited) by the rate that the glass-forming ribbon is moving in the draw direction 154. In some embodiments, as shown in FIG. 6, the residence time can be controlled (e.g., adjusted, limited) by the rate that the energy 317 (e.g., laser beam 701) is scanned across the portion of the first major surface 103a. In further embodiments, the residence time can include multiple passes of the energy (e.g., laser beam 701), for example, when the scan rate is sufficiently high and/or the draw rate in the draw direction 154 is sufficiently low that the location 315 can be within an area of the energy (e.g., laser beam 701) impinging the first major surface 103a on both a first pass and a second pass of the energy (e.g., laser beam 701). In some embodiments, as shown in FIGS. 7-8, the residence time can be controlled (e.g., adjusted, limited) by controlling the area (e.g., the width 705, 805 and/or the height measured perpendicular to the width 705, 805) of the energy 317 (e.g., laser beam 701, light emitted from the flame 801) impinging the first major surface 103a. In further embodiments, the energy 317 can comprise the laser beam 701, and the width 705 of the laser beam 701 can be controlled, for example, by placing and/or adjusting optics between the laser 703 and the first major surface 103a. In further embodiments, as shown in FIG. 8, the energy 317 can comprise light emitted from the flame 801, and the width 805 of the flame 801 can be controlled, for example, by adjusting a shape of the burner 803. In some embodiments, the residence time can be about 0.0001 seconds (s) or more, about 0.001 s or more, about 0.01 s or more, about 1 s or more, about 120 s or less, about 60 s or less, about 10 s or less, about 1 s or less, or about 0.1 s or less. In some embodiments, the residence time can be in a range from about 0.0001 s to about 120 s, from about 0.0001 s to about 60 s, from about 0.0001 s to about 10 s, from about 0.0001 s to about 1 s, from about 0.0001 s to about 0.1 s, from about 0.001 s to about 120 s, from about 0.001 s to about 60 s, from about 0.001 s to about 10 s, from about 0.001 s to about 1 s, from about 0.001 s to about 0.1 s, from about 0.01 s to about 120 s, from about 0.01 s to about 60 s, from about 0.01 s to about 10 s, from about 0.01 s to about 1 s, from about 0.01 s to about 0.1 s, or any range or subrange therebetween.

In some embodiments, impinging the glass-forming ribbon with the energy can heat the glass-forming ribbon comprising the glass-forming material to a heating depth. Throughout the disclosure, the heating depth at a location on the surface of the glass-forming ribbon comprising the glass-forming material is defined as the sum of the absorption depth of the glass-forming material and the square root of the product of the thermal diffusivity of the glass-forming material and the residence time of the energy at the location. As discussed above, the absorption depth of the glass-forming material of energy comprising multiple wavelengths is defined as the weighted average of the absorption depth at each wavelength weighted by the percentage of the energy’s intensity comprising the corresponding wavelength. Without wishing to be bound by theory, non-light energy transferred from the flame to the glass-forming ribbon (e.g., by conduction and/or convection) can be absorbed substantially within less than 1 µm from the corresponding surface and thus does not significantly impact the absorption depth of a total energy transmitted from the flame.

In some embodiments, the location 315 on the first major surface 103a can be heated to a heating depth of about 250 micrometers (µm) or less, about 100 µm or less, about 50 micrometers or less, about 30 µm or less, about 20 µm or less, about 10 µm or less, about 8 µm or less, about 5 µm or less, about 0.1 µm or more, about 1 µm or more, about 5 µm or more, or about 8 µm or more. In some embodiments, the location 315 on the first major surface 103a can be heated to a heating depth in a range from about 0.1 µm to about 250 µm, from about 0.1 µm to about 100 µm, from 0.1 µm to about 50 µm, from about 0.1 µm to about 30 µm, from about 0.1 µm to about 20 µm, from about 0.1 µm to about 10 µm, from about 0.1 µm to about 8 µm, from about 0.1 µm to about 5 µm, from about 1 µm to about 250 µm, from about 1 µm to about 100 µm, from about 1 µm to about 50 µm, from about 1 µm to about 30 µm, from about 1 µm to about 10 µm, from about 1 µm to about 10 µm, from about 1 µm to about 8 µm, from about 1 µm to about 5 µm, from about 5 µm to about 250 µm, from about 5 µm to about 100 µm, from about 5 µm to about 50 µm, from about 5 µm to about 30 µm, from about 5 µm to about 10 µm, from about 5 µm to about 8 µm, from about 8 µm to about 250 µm, from about 8 µm to about 100 µm, from about 8 µm to about 50 µm, from about 8 µm to about 50 µm, from about 8 µm to about 20 µm, from about 8 µm to about 10 µm, or any range or subrange therebetween. Providing energy to heat the location on the surface of the glass-forming ribbon such that a heating depth of the glass-forming ribbon is small (e.g., about 250 µm or less, about 50 µm or less, about 10 µm or less) can enable a reduction of the surface roughness of the glass-forming ribbon at the first major surface without substantially changing the thickness of the glass-forming ribbon, without deforming the bulk of the glass-forming ribbon, and without substantially heating the rest of the glass-forming ribbon at the target location 307.

Impinging the first major surface 103a of the glass-forming ribbon at the target location 307 of the travel path 311 with energy 317 can heat the first major surface 103a of the glass-forming ribbon by increasing a temperature of the glass-forming ribbon at the target location 307. In some embodiments, the energy 317 (e.g., laser beam 701, light emitted from the flame 801) emitted from one or more heating elements 303 (e.g., laser 703, burner 803) can heat the first major surface 103a of the glass-forming ribbon as the energy (e.g., laser beam 701, light emitted from the flame 801) is absorbed by a portion of the glass-forming material (e.g., within the absorption depth, within the heating depth), which increases the temperature of the glass-forming material. In some embodiments, as shown in FIGS. 7-8, the temperature can increase at the location 315 within the heating depth of the first major surface and decrease the viscosity of the glass-forming material at the location 315 such that a melt pool 709, 809 forms to a pool depth 707, 807 from the first major surface 103a at the location 315. In further embodiments, the pool depth 707, 807 can be within one or more of the ranges discussed above for the absorption depth and/or heating depth. In further embodiments, the glass-forming material in the melt pool 709, 809 can comprise a viscosity of about 100 Pa-s or more, about 200 Pa-s or more, about 500 Pa-s or more, about 1,000 Pa-s or less, about 800 Pa-s or less, or about 500 Pa-s or less. In further embodiments, the glass-forming material in the melt pool 709, 809 can comprise a viscosity in a range from about 100 Pa-s to about 1,000 Pa-s, from about 200 Pa-s to about 1,000 Pa-s, from about 500 Pa-s to about 1,000 Pa-s, from about 100 Pa-s to about 800 Pa-s, from about 200 Pa-s to about 800 Pa-s, from about 500 Pa-s to about 800 Pa-s, from about 100 Pa-s to about 500 Pa-s, from about 200 Pa-s to about 500 Pa-s, or any range or subrange therebetween. Without wishing to be bound by theory, glass-forming material comprising a viscosity of about 1,000 Pa-s or less can smooth surface roughness through surface tension.

In some embodiments, the heating can increase a temperature at the location 315 on the first major surface 103a by about 50° C. or more, 100° C. or more, about 200° C. or more, about 250° C. or more, about 500° C. or less, about 400° C. or less, about 350° C. or less, or about 300° C. or less. the heating can increase a temperature at the location 315 on the first major surface 103a in a range from about 50° C. to about 500° C., from about 100° C. to about 500° C., from about 200° C. to about 500° C., from about 250° C. to about 500° C., from about 50° C. to about 400° C., from about 100° C. to about 400° C., from about 200° C. to about 400° C., from about 250° C. to about 400° C., from about 50° C. to about 350° C., from about 100° C. to about 350° C., from about 200° C. to about 350° C., from about 250° C. to about 350° C., from about 100° C. to about 300° C., from about 200° C. to about 300° C., from about 250° C. to about 300° C., or any range or subrange therebetween.

In some embodiments, as shown in FIGS. 2-6, the second heating apparatus 215b can heat the second major surface 103b of the glass-forming ribbon at the target location 307 of the travel path 311 while the glass-forming ribbon is traveling along the travel path 311 in the draw direction 154. In further embodiments, as shown in FIG. 5, the second heating apparatus 215b can comprise one or more heating elements 303 that can comprise one or more lasers 703 emitting energy 321 comprising a laser beam 701 impinging a location 319 on the second major surface 103b of the glass-forming ribbon at the target location 307. In further embodiments, the second heating apparatus 215b can comprise one or more heating elements 303 that can comprise one or more burners 803 emitting energy 321 comprising a flame 801 emitting light that impinges a location 319 on the second major surface 103b of the glass-forming ribbon at the target location 307. In some embodiments, impinging the second major surface 103b of the glass-forming ribbon at the location 319 with the energy 321 can heat the glass-forming ribbon comprising the glass-forming material to a heating depth from the second major surface 103b can be within one or more of the ranges discussed above with regards to the heating depth from the first major surface 103a.

Methods can comprise cooling the glass-forming ribbon into the glass ribbon 103 after the heating with the heating apparatus 215a, 215b. In some embodiments, as shown in FIG. 1, the glass ribbon 103 can be divided into a plurality of glass sheets 104.

The first major surface 103a of the glass ribbon 103 can comprise a surface roughness (Ra). Throughout the disclosure, all surface roughness values set forth in the disclosure are a surface roughness (Ra) calculated using an arithmetical mean of the absolute deviations of a surface profile from an average position in a direction normal to the surface of a test area of 10 µm by 10 µm as measured using atomic force microscopy (AFM). The surface roughness can be measured before subsequent processing of the glass ribbon. As used herein, “subsequent process” means mechanical grinding, mechanical polishing, chemically etching, and/or remelting. Without wishing to be bound by theory, subsequent processing can reduce the surface roughness of at least one major surface of the resulting glass ribbon. In some embodiments, the surface roughness (Ra) of the first major surface 103a and/or the second major surface 103b of the glass ribbon 103 can be about 5 nm or less, about 3 nm or less, about 2 nm or less, about 1 nm or less, about 0.9 nm or less, 0.5 nm or less, about 0.3 nm or less, about 0.1 nm or more, about 0.15 nm or more, or about 0.2 nm or more. In some embodiments, the surface roughness (Ra) of the first major surface 103a and/or the second major surface 103b of the glass ribbon 103 can be in a range from about 0.1 nm to about 5 nm, from about 0.1 nm to about 3 nm, from about 0.1 nm to about 2 nm, from about 0.1 nm to about 1 nm, from about 0.1 nm to about 0.9 nm, from about 0.1 nm to about 0.5 nm, from about 0.1 nm to about 0.3 nm, from about 0.15 nm to about 5 nm, from about 0.15 nm to about 3 nm, from about 0.15 nm to about 2 nm, from about 0.15 nm to about 1 nm, from about 0.15 nm to about 0.9 nm, from about 0.15 nm to about 0.5 nm, from about 0.15 nm to about 0.3 nm, from about 0.2 nm to about 5 nm, from about 0.2 nm to about 3 nm, from about 0.2 nm to about 2 nm, from about 0.2 nm to about 1 nm, from about 0.2 nm to about 0.9 nm, from about 0.2 nm to about 0.5 nm, from about 0.2 nm to about 0.3 nm, or any range or subrange therebetween.

In some embodiments, the surface roughness (Ra) of a first glass ribbon according to embodiments of the disclosure as a percentage of a surface roughness (Ra) of a second glass ribbon manufactured identically to the first glass ribbon except for the heating with the treatment apparatus 170 (e.g., heating apparatus 215a, 215b, one or more heating elements 303, laser 703, burner 803) can be about 0.01% or more, about 0.1% or more, about 0.2% or more, about 0.4% or more, about 1% or more, about 5% or less, about 2.5% or less, about 1% or less, or about 0.6% or less. In some embodiments, the surface roughness (Ra) of a first glass ribbon according to embodiments of the disclosure as a percentage of a surface roughness (Ra) of a second glass ribbon manufactured identically to the first glass ribbon except for the heating with the treatment apparatus 170 (e.g., heating apparatus 215a, 215b, one or more heating elements 303, laser 703, burner 803) can be in a range from about 0.01% to about 5%, from about 0.1% to about 5%, from about 0.2% to about 5%, from about 0.4% to about 5%, from about 1% to about 5%, from about 0.01 % to about 2.5%, from about 0.1% to about 2.5%, from about 0.2% to about 2.5%, from about 0.4% to about 2.5%, from about 0.6% to about 2.5%, from about 1% to about 2.5%, from about 0.01% to about 1%, from about 0.1% to about 1%, from about 0.2% to about 1%, from about 0.4% to about 1%, from about 0.01% to about 0.6%, from about 0.1% to about 0.6%, from about 0.2% to about 0.6%, from about 0.4% to about 0.6%, or any range or subrange therebetween.

An electronic product, for example a consumer electronic product, may include a housing comprising a front surface, a back surface, and side surfaces; electrical components at least partially within the housing, the electrical components comprising a controller, a memory, and a display, the display at or adjacent the front surface of the housing; and a cover substrate disposed over the display, wherein at least one of a portion of the housing or the cover substrate comprises the foldable apparatus described herein.

Embodiments of the disclosure can comprise an electronic product. The electronic product can comprise a front surface, a back surface, and side surfaces. The electronic product can further comprise electrical components at least partially within the housing. The electrical components can comprise a controller, a memory, and a display. The display can be at or adjacent the front surface of the housing. The electronic product can comprise a cover substrate disposed over the display. In some embodiments, at least one of a portion of the housing or the cover substrate comprises the foldable apparatus discussed throughout the disclosure.

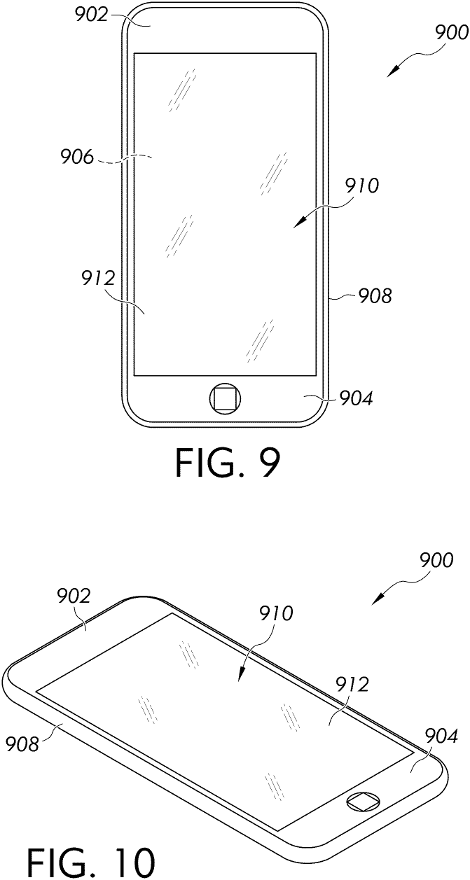

The foldable apparatus disclosed herein may be incorporated into another article, for example, an article with a display (or display articles) (e.g., consumer electronics, including mobile phones, tablets, computers, navigation systems, wearable devices (e.g., watches) and the like), architectural articles, transportation articles (e.g., automotive, trains, aircraft, sea craft, etc.), appliance articles, or any article that may benefit from some transparency, scratch-resistance, abrasion resistance or a combination thereof. An exemplary article incorporating any of the foldable apparatus disclosed herein is shown in FIGS. 9 and 10. Specifically, FIGS. 9 and 10 show an electronic device 900 including a housing 902 having front 904, back 906, and side surfaces 908; electrical components (not shown) that are at least partially inside or entirely within the housing and including at least a controller, a memory, and a display 910 at or adjacent to the front surface of the housing; and a cover substrate 912 at or over the front surface of the housing such that it is over the display. In some embodiments, at least one of the cover substrate 912 or a portion of housing 902 may include any of the foldable apparatus disclosed herein.

In some embodiments, methods of making an electronic product can comprise placing electrical components at least partially within a housing, the housing comprising a front surface, a back surface, and side surfaces, and the electrical components comprising a controller, a memory, and a display, wherein the display is placed at or adjacent the front surface of the housing. The methods can further comprise disposing a cover substrate over the display. At least one of a portion of the housing or the cover substrate comprises a portion of the glass ribbon manufactured by any of the methods of the disclosure.

### EXAMPLES

Various embodiments will be further clarified by the following examples. The surface roughness (Ra) of Examples A-D is reported in Table I. Example A comprises a glass ribbon formed by press rolling without the treatment apparatus of embodiments of the disclosure. Examples B-D were produced in the same method as Example A except that the first major surface of the glass-forming ribbon was treated with a CO₂ laser when a glass sheet produced from the glass-forming ribbon was heated to an average temperature of 650° C. at the target location. The CO₂ was operated as a CW laser emitting 360W with a laser beam comprising a width of 10 mm was scanned across the first major surface with 20 mm between passes. In Example B, the scan rate was 2,000 mm/s. In example C, the scan rate was 3,000 mm/s. In Example D, the scan rate was 4,000 mm/s. No subsequent process was performed on any of Examples A-D.

TABLE 1

Surface Roughness (Ra) of Examples A-D

| Example | Surface Roughness (Ra) (nm) |
|---|---|
| A | 44.05 |
| B | 0.22 |
| C | 0.22 |
| D | 0.86 |

As shown in Table I, the thermal treatment reduced the surface roughness (Ra) to less than 1 nm for Examples B-D (2.7% of Example A). Further, Examples B-C both comprise a surface roughness (Ra) of less than 0.3 nm (0.9% of Example A). Relative to Examples B-C, Example D has a higher surface roughness (Ra). The surface roughness (Ra) is still much lower than Example A, but decreasing the scan rate of Example D would decrease the surface roughness. The similarity of the surface roughness of Examples B-C suggest that the scan rate of Example C is a good balance of reducing surface roughness and processing efficiency.

Embodiments of the disclosure can provide for high-quality glass ribbons and/or glass sheets. Heating a portion of a glass-forming ribbon to a small (e.g., 50 micrometers or less, 10 micrometers or less) depth from the first major surface can produce a glass ribbon and/or glass sheet with low surface roughness (e.g., about 5 nanometers or less). Further, the heating of the glass-forming ribbon can significantly reduce the surface roughness of the glass ribbon relative to forming a second glass ribbon without the heating (e.g., about 5% or less or in a range from about 0.01 to about 1% of the second glass ribbon’s surface roughness). The heating can provide the above-mentioned low surface roughness without subsequent processing (e.g., chemical etching, mechanical grinding, mechanical polishing) of the glass ribbon and/or glass sheet. Providing the heating of the glass-forming ribbon can reduce and/or eliminate surface roughness introduced, for example, by rollers and/or a forming device. Reducing the surface roughness can enable the resulting glass ribbons and/or glass sheets to meet more stringent design specifications on surface roughness while reducing waste from non-conforming glass ribbons and/or glass sheets.

Embodiments of the disclosure can increase processing efficiency in manufacturing glass ribbons. Heating the glass-forming ribbon when the glass-forming ribbon is in a viscous state (e.g., from about 1,000 Pascal-seconds to about 10¹¹ Pascal-seconds) can be performed inline with other aspects of manufacturing the glass-ribbon, for example, between the forming device and dividing the glass ribbon into a plurality of glass sheets. Inline heating can reduce the time and/or space requirements for manufacturing the glass ribbon since demand for subsequent processing of the glass ribbon and/or glass sheet can be reduced and/or eliminated. Additionally, the labor and/or equipment costs associated with subsequent processing of the glass ribbon and/or glass sheet can be reduced and/or eliminated.

Embodiments of the disclosure can comprise heating the glass-forming ribbon when the glass-forming ribbon is at an elevated temperature (e.g., from about 500° C. to about 1300° C.). Heating the glass-forming ribbon when the glass-forming ribbon is at an elevated temperature can produce a glass ribbon and/or glass sheet with low or no residual stress from the heating, for example, because the glass-forming ribbon is in the viscous regime during the heating, which allow the dissipation of stresses. Additionally, heating the glass-forming ribbon when the glass-forming ribbon is at an elevated temperature can reduce energy required to heat a portion of the glass-forming ribbon within a small (e.g., 50 micrometers or less, 10 micrometers or less) depth from the first major surface to obtain a sufficient temperature and/or viscosity to reduce the surface roughness.

Embodiments of the disclosure can localize the heating of the glass-forming ribbon to a small (e.g., 50 micrometers or less, 10 micrometers or less) depth from the first major surface. Localizing the heating can decrease a viscosity of the portion (e.g., from about 100 Pascal-seconds to about 1,000 Pascal-seconds), which can, for example, facilitate smoothing of the first major surface via surface tension of the glass-forming material comprising the glass-forming ribbon. Additionally, localizing the heating can decrease the surface roughness of the first major surface without significantly heating the rest of the thickness of the glass-forming ribbon at that location, which can prevent changes in thickness or deformation of the shape of the glass-forming ribbon. Also, localizing the heating can reduce the energy required to reduce the surface roughness of the first major surface. Further reduction in the energy required and/or preventing deformation of the glass-forming ribbon can be enabled by selecting heating comprising a small absorption depth (e.g., about 10 micrometers or less) and/or selecting a residence time of the heating to heat the glass-forming ribbon to a small heating depth (e.g., about 50 micrometers or less).

As used herein, the terms “the,” “a,” or “an,” mean “at least one,” and should not be limited to “only one” unless explicitly indicated to the contrary. Thus, for example, reference to “a component” comprises embodiments having two or more such components unless the context clearly indicates otherwise.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an endpoint of a range, the disclosure should be understood to comprise the specific value or endpoint referred to. If a numerical value or endpoint of a range in the specification recites “about,” the numerical value or endpoint of a range is intended to comprise two embodiments: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, for example within about 5% of each other, or within about 2% of each other.

As used herein, the terms “comprising” and “including,” and variations thereof, shall be construed as synonymous and open ended, unless otherwise indicated. A list of elements following the transitional phrases comprising or including is a non-exclusive list, such that elements in addition to those specifically recited in the list may also be present.

While various embodiments have been described in detail with respect to certain illustrative and specific embodiments thereof, the present disclosure should not be considered limited to such, as numerous modifications and combinations of the disclosed features are possible without departing from the scope of the following claims.

What is claimed is:

1. A method of manufacturing a glass ribbon comprising:
flowing a glass-forming ribbon along a travel path, the glass-forming ribbon comprising a first major surface, a second major surface opposite the first major surface, a thickness defined between the first major surface and the second major surface, and a width extending across the travel path;
heating the first major surface of the glass-forming ribbon at a target location of the travel path while the glass-forming ribbon is travelling along the travel path, the heating increasing a temperature of the glass-forming ribbon at the target location to a heating depth of about 250 micrometers or less from the first major surface; and
cooling the glass-forming ribbon into the glass ribbon,
wherein prior to the heating, the glass-forming ribbon at the target location comprises an average viscosity in a range from about 1,000 Pascal-seconds to about 10¹¹ Pascal-seconds.

2. The method of claim 1, further comprising contacting the first major surface of the glass-forming ribbon across substantially the entire width of the glass-forming ribbon with a roller at a location on the travel path upstream of the target location.

3. The method of claim 1, further comprising forming the glass-forming ribbon by flowing glass-forming material through an orifice of a forming device.

4. The method of claim 1, wherein the average viscosity at the target location is in a range from about 1,000 Pascal-seconds to about 10^{6.6} Pascal-seconds.

5. (canceled)

6. (canceled)

7. The method of claim 1, wherein prior to the heating, an average temperature of the glass-forming ribbon at the target location is in a range from about 500° C. to about 1300° C.

8. The method of claim 7, wherein the average temperature of the glass-forming ribbon at the target location is in a range from about 750° C. to about 1250° C.

9. (canceled)

10. (canceled)

11. The method of claim 1, wherein a surface roughness Ra of the first major surface of the glass ribbon before subsequent processing of the glass ribbon is about 5 nanometers or less.

12. (canceled)

13. The method of claim 11, wherein the surface roughness Ra of the first major surface of the glass ribbon before subsequent processing of the glass ribbon is about 5% or less than a surface roughness Ra of a second glass ribbon before subsequent processing of the second glass ribbon, wherein the second glass ribbon is manufactured identically to the glass ribbon except for the heating.

14. (canceled)

15. The method of claim 1, wherein the heating the first major surface at the target location transfers energy to the glass-forming ribbon at a rate in a range from about 0.1 kilowatt per square centimeter to about 100 kilowatt per square centimeter.

16. (canceled)

17. (canceled)

18. The method of claim 1, wherein the heating depth is about 10 micrometers or less.

19. The method of claim 1, wherein an absorption depth of a glass-forming material of the glass-forming ribbon at the target location during the heating the first major surface is about 50 micrometers or less.

20. (canceled)

21. The method of claim 1, further comprising heating the second major surface of the glass-forming ribbon at a second target location of the travel path while the glass-forming ribbon is travelling along the travel path, the heating increasing a temperature of the glass-forming ribbon at the second target location to a heating depth of 250 micrometers or less from the second major surface.

22. (canceled)

23. The method of claim 21, wherein a surface roughness Ra of the second major surface of the glass ribbon before subsequent processing of the glass ribbon is about 5 nanometers or less.

24. (canceled)

25. The method of claim 23, wherein the surface roughness Ra of the second major surface of the glass ribbon before subsequent processing of the glass ribbon is about 5% or less than a surface roughness Ra of a second glass ribbon before subsequent processing of the second glass ribbon, wherein the second glass ribbon is manufactured identically to the glass ribbon except for the heating.

26. (canceled)

27. The method of claim 25, wherein the heating the second major surface of the glass-forming ribbon at the second target location transfers energy to the second major surface at a rate in a range from about 0.1 kilowatts per square centimeter to about 100 kilowatts per square centimeter.

28. (canceled)

29. The method of claim 1, wherein the heating comprises impinging the first major surface of the glass-forming ribbon at the target location with a laser beam.

30. The method of claim 29, wherein the laser beam comprises a wavelength in a range from about 1.5 micrometers to about 20 micrometers.

31. (canceled)

32. (canceled)

33. The method of claim 29, wherein a width of the laser beam in a direction transverse to the travel path is about 50% or more of the width of the glass-forming ribbon at the target location.

34. (canceled)

35. The method of claim 29, further comprising scanning the laser beam across a portion of the width of the glass-forming ribbon at the target location.

36. (canceled)

37. The method of claim 29, wherein the impinging comprises impinging the first major surface at the target location with a plurality of laser beams.

38. The method of claim 37, wherein the plurality of laser beams impinging the glass-forming ribbon at the target location are arranged in a row along a direction of the width of the glass-forming ribbon.

39. The method of claim 29, wherein the laser beam is a substantially continuous laser beam comprising a substantially constant fluence.

40-46. (canceled)
